(19) United States
(12) Patent Application Publication
(10) Pub. No.: US 2008/0147321 A1
(43) Pub. Date: Jun. 19, 2008

(54) Integrating Navigation Systems

(76) Inventors: Damian Howard, Winchester, MA (US); Douglas C. Moore, North Grafton, MA (US); Kenneth S. Yoshioka, Sutton, MA (US); Melina Apostolopoulos, Arlington, MA (US)

Correspondence Address: FISH & RICHARDSON PC, P.O. BOX 1022, MINNEAPOLIS, MN, 55440-1022, US

(21) Appl. No.: 11/750,822

(22) Filed: May 18, 2007

Related U.S. Application Data
(63) Continuation-in-part of application No. 11/612,003, filed on Dec. 18, 2006.

(51) Int. Cl. G01C 21/00

(52) U.S. Cl. 701/211; 455/3.06

(57) ABSTRACT

Vehicle data generated by circuitry of a vehicle is received and functions of a personal navigation device, which are otherwise used to process device navigational data that are generated by navigational circuitry in the personal navigation device, are used to process the vehicle data to produce output navigational information.

User interlace commands and navigational data are communicated between a personal navigation device and a media head unit of a vehicle, the user interface commands and navigational data being associated with a device user interface of the device, and a vehicle navigation user interface at the media head unit displays navigational information and receives user input for control the display of the navigational information on the media head unit, the vehicle navigation user interface being coordinated with the user interface commands and navigational data associated with the device user interface.

### CROSS-REFERENCE TO RELATED APPLICATION

This application is a continuation-in-part of prior U.S. patent application Ser. No. 11/612,003, filed Dec. 18, 2006, the contents of which are incorporated by reference.

### TECHNICAL FIELD

This disclosure relates to integrating navigation systems.

### BACKGROUND

In-vehicle entertainment systems and portable navigation systems sometimes include graphical displays, touch-screens, physical user-interface controls, and interactive or one-way voice interfaces. They may also be equipped wife telecommunication interfaces including terrestrial or satellite radio, Bluetooth, GPS, and cellular voice and data technologies. Entertainment systems integrated into vehicles may have access to vehicle data, including speed and acceleration, navigation, and collision event data. Navigation systems may include databases of maps and travel information and software for computing driving directions. Navigation systems and entertainment systems may be integrated or may be separate components.

### SUMMARY

In general, in one aspect, personal navigation device includes an interface capable of receiving navigation input data from a media device; a processor structured to generate a visual element indicating a current location from the navigation input data; a frame buffer to store the visual element; and a storage device in which software is stored that when executed by the processor causes the processor to repeatedly check the visual element in the frame buffer to determine if the visual element has been updated since a previous instance of checking the visual element, and compress the visual element and transmit the visual element to the media device if the visual element has not been updated between two instances of checking the visual element.

In general, in one aspect, a method includes receiving navigation input data from a media device, generating a visual element indicating a current location from the navigation input data, storing the visual element in a storage device of a personal navigation device, repeatedly checking the visual element in the storage device to determine if the visual element has been updated between two instances of checking the visual element, and compressing the visual element and transmitting the visual element to the media device if the visual element has not been updated between two instances of checking the visual element.

In general, in one aspect, a computer readable medium encoding instructions to cause a personal navigation device to receive navigation input data from a media device; repeatedly check a visual element that is generated by the personal navigation device from the navigation input data, is stored by the personal navigation device, and that indicates a current position, to determine if the visual element has been updated between two instances of checking the visual element; and compress the visual element and transmit the visual element to the media device if the visual element has not been updated between two instances of checking the visual element.

Implementations of the above may include one or more of the following features. Loss-less compression is employed to compress the visual element. It is determined if the visual element has been updated by comparing every Nth horizontal line of the visual element from a first instance of checking the visual element to corresponding horizontal lines of the visual element from a second instance of checking the visual element, wherein N has a value of at least 2. The visual element is compressed by serializing pixels of the visual element into a stream of serialized pixels and creating a description of the serialized pixels in which a given pixel color is specified when the pixel color is different from a preceding pixel color and in which the specification of the given pixel color is accompanied by a value indicating the quantity of adjacent pixels that have the given pixel color. The media device is installed within a vehicle, and the navigation input data includes data from at least one sensor of the vehicle. A piece of data pertaining to a control of the personal navigation device is transmitted to the media device to enable the media device to assign a control of the media device as a proxy for the control of the personal navigation device. The software further causes the processor to receive a indication of an actuation of the control of the media device and respond to the indication in a manner substantially identical to the manner in which an actuation of the control of the personal navigation device is responded to. The repeated checking of the visual element to determine if the visual element has been updated entails repeatedly checking the frame buffer to determine if the entirety of the frame buffer has been updated.

In general, in one aspect a media device includes an interlace capable of receiving a visual element indicating a current location from a personal navigation device; a screen; a processor structured to provide an image indicating the current location and providing entertainment information for display on the screen from at least the visual element; and a storage device in which software is stored that when executed by the processor causes the processor to define a first layer and a second layer, store the visual element in the second layer, store another visual element pertaining to the entertainment information in the first, layer, and combine the first layer and the second layer to create the image with the first layer overlying the second layer such that the another visual element overlies the visual element.

In general in one aspect, a method includes receiving a visual element indicating a current location from a personal navigation device, defining a first layer and a second layer, storing the visual element in the second layer, storing another visual element pertaining to the entertainment information in the first layer, combining the first layer and the second layer to provide an image with the first layer overlying the second layer such that the another visual element overlies the visual element, and displaying the image on a screen of a media device.

In general, in one aspect, a computer readable medium encoding instructions to cause a media device to receive a visual element indicating a current location from a personal navigation device, define a first layer and a second layer, store the visual element in the second layer, store another visual element pertaining to the entertainment information in the first layer, combine the first layer and the second layer to provide an image with the first layer overlying the second layer such that the another visual element overlies the visual element, and display the image on a screen of the media device.

Implementations of the above may include one or more of the following features. The media device of claim further includes a receiver capable of receiving a GPS signal from a satellite, wherein the processor is further structured to provide navigation input data corresponding to that GPS signal to the personal navigation device. The software further causes the processor to alter a visual characteristic of the visual element. The visual characteristic of the visual element is one of a set consisting of a color, a font and a shape. The visual characteristic that is altered is a color, and wherein the color is altered to at least approximate a color of a vehicle into which the media device is installed. The visual characteristic that is altered is a color, and wherein the color is altered to at least approximate a color specified by a user of the media device. The media device further includes a physical control and the software further causes the processor to assign the physical control to serve as a proxy for a control of the personal navigation device. The control of the personal navigation device is a physical control of the personal navigation device. The control of the personal navigation device is a virtual control having a corresponding additional visual element that is received from the personal navigation device and that the software further causes the processor to refrain from displaying on the screen. The media device further includes a proximity sensor, and the software further causes the processor to alter at least a portion of the another visual element in response to detecting the approach of a portion of the body of a user of the media device through the proximity sensor. The another visual element is enlarged such that it overlies a relatively larger portion of the visual element.

In general, in one aspect, a media device includes at least one speaker; an interlace enabling a connection between the media device and a personal navigation device to be formed, and enabling audio data stored on the personal navigation device to be played on the at least one speaker; and a user interface comprising a plurality of physical controls capable of being actuated by a user of the media device to control a function of the playing of the audio data stored on the personal navigation device during a time when there is a connection between the media device and the personal navigation device.

In general, in one aspect a method includes detecting that a connection exists with a personal navigation device and a media device, receiving audio data from the personal navigation device, playing the audio data through at least one speaker of the media device; and transmitting a command to the personal navigation device pertaining to the playing of the audio data in response to an actuation of at least one physical control of the media device.

Implementations of the above may include one or more of the following features. The media device is structured to interact with the personal navigation device to employ a screen of the personal navigation device as a component of the user interface of the media device during a time when there is a connection between the media device and the personal navigation device. The media device is structured to assign the plurality of physical controls to serve as proxies for a corresponding plurality of controls of the personal navigation device during a time when the screen of the personal navigation device is employed as a component of the user interlace of the media device. The media device is structured to transmit to the personal navigation device an indication of a characteristic of the user interface of the personal navigation device to be altered during a time when there is a connection between the media device and the personal navigation device. The characteristic of the user interface of the personal navigation device to be altered is one of a set consisting of a color, a font, and a shape of a visual element displayed on a screen of the personal navigation device. The media device is structured to accept commands from the personal navigation device during a time when there is a wireless connection between the media device and the personal navigation device to enable the personal navigation device to serve as a remote control of the media device. The media device further includes an additional interface enabling a connection between the media device and another media device through which the media device is able to relay a command received from the personal navigation device to the another media device.

Other features and advantages of the invention will he apparent from the description and the claims.

### DESCRIPTION

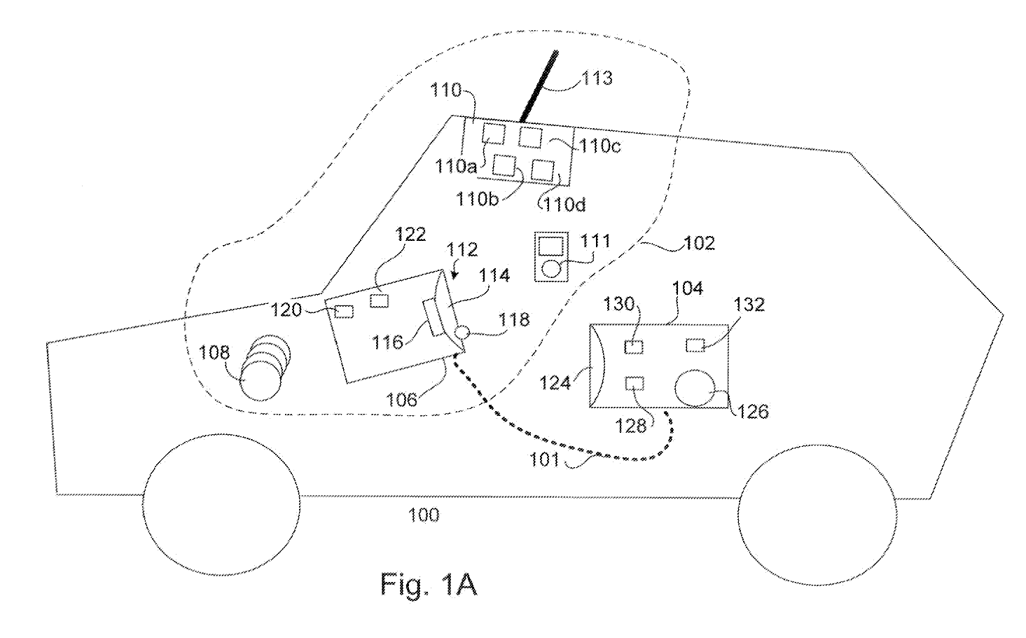

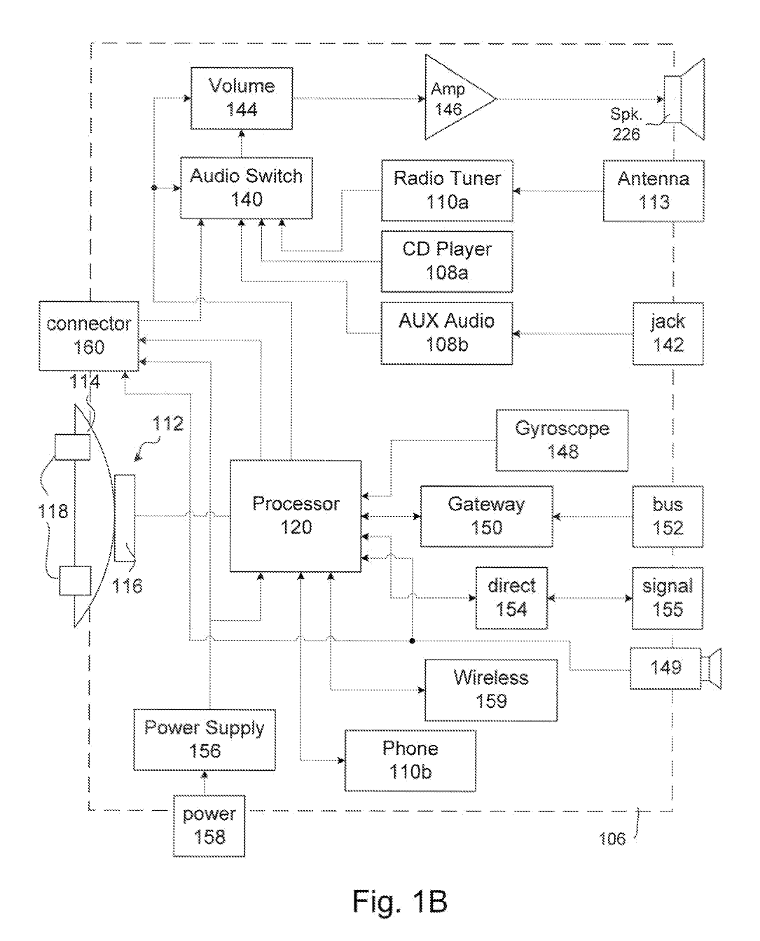

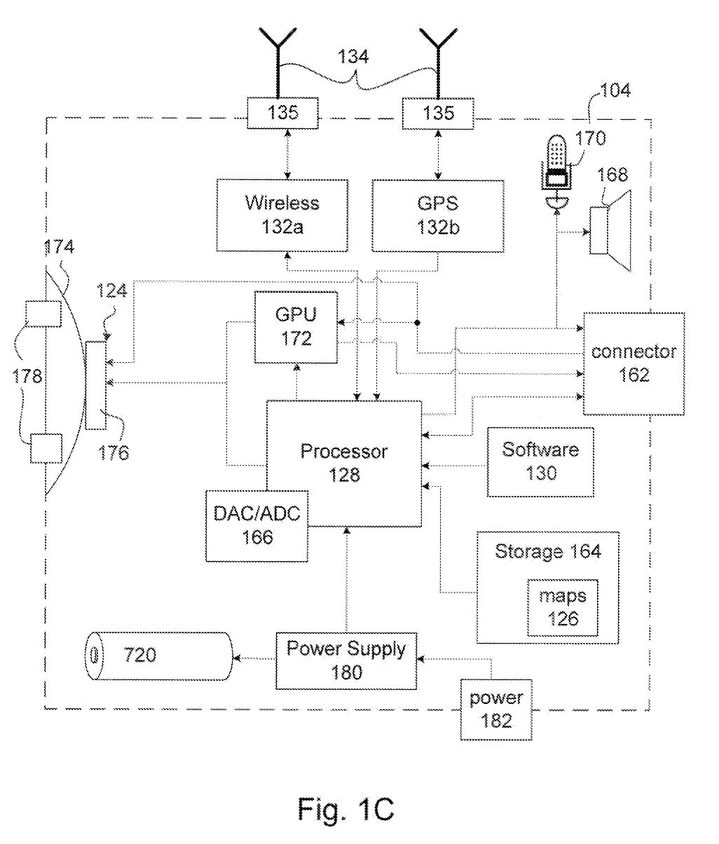

FIGS. 1A, 1, 8A-88, and 9 are block diagrams of a vehicle information system.

FIG. 1B is a block diagram of a media head unit.

FIG. 1C is a block diagram of a portable navigation system.

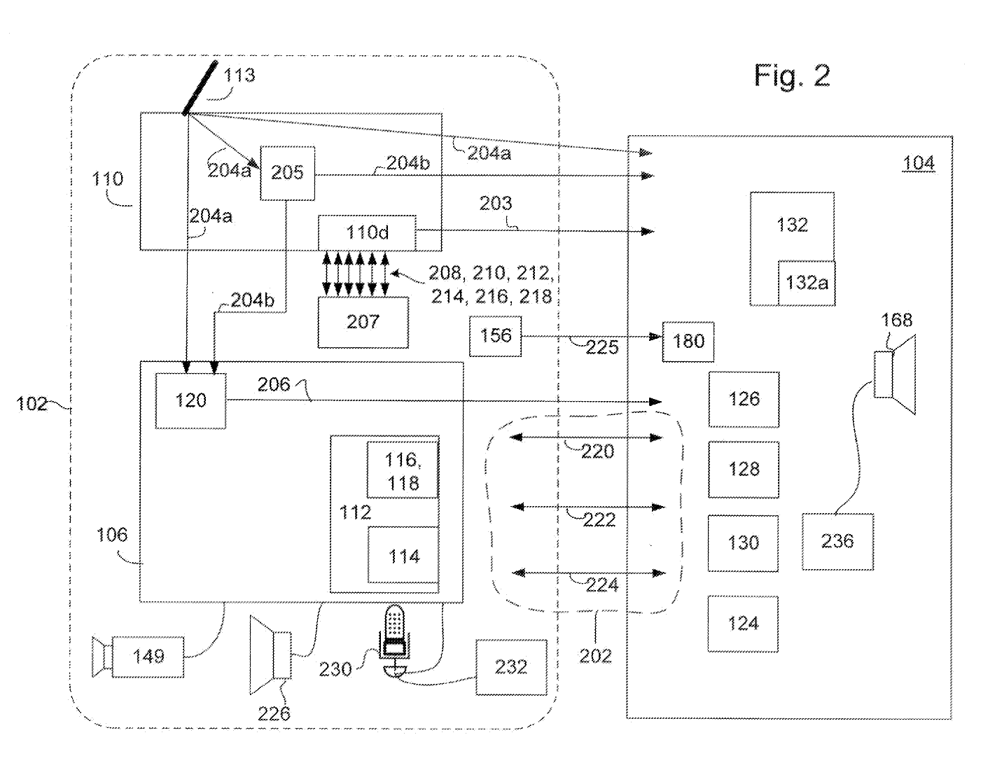

FIGS. 2, 5, 10, and 11 are block diagrams showing communication between a vehicle entertainment system and a portable navigation system.

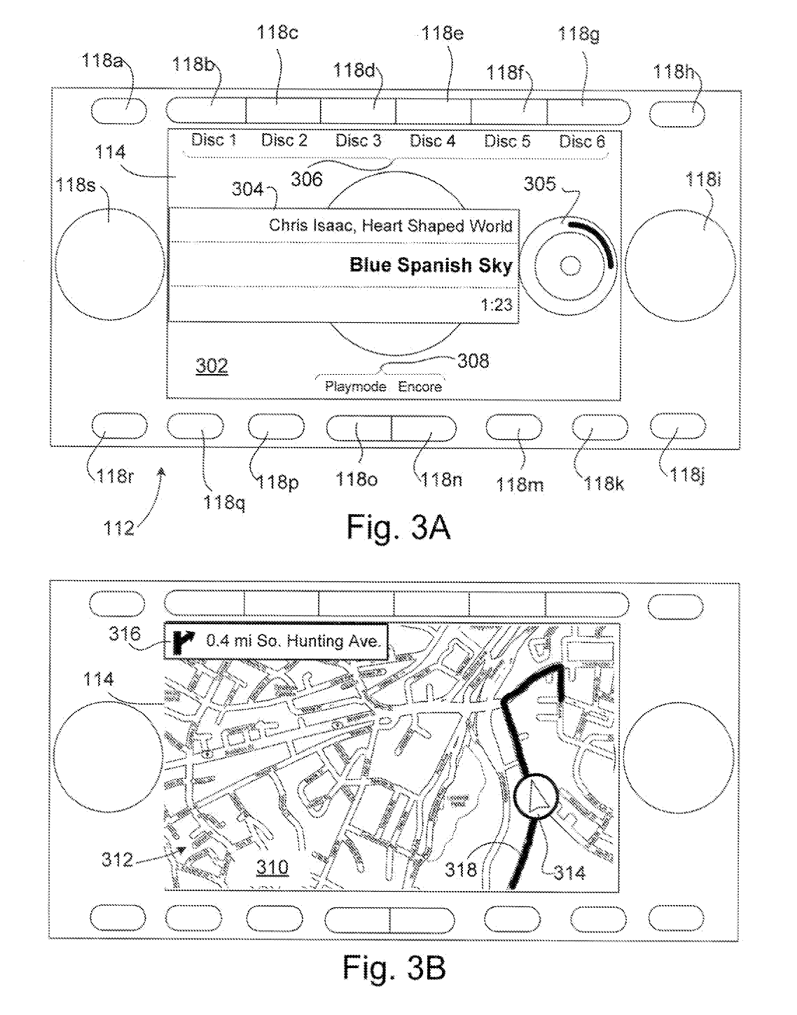

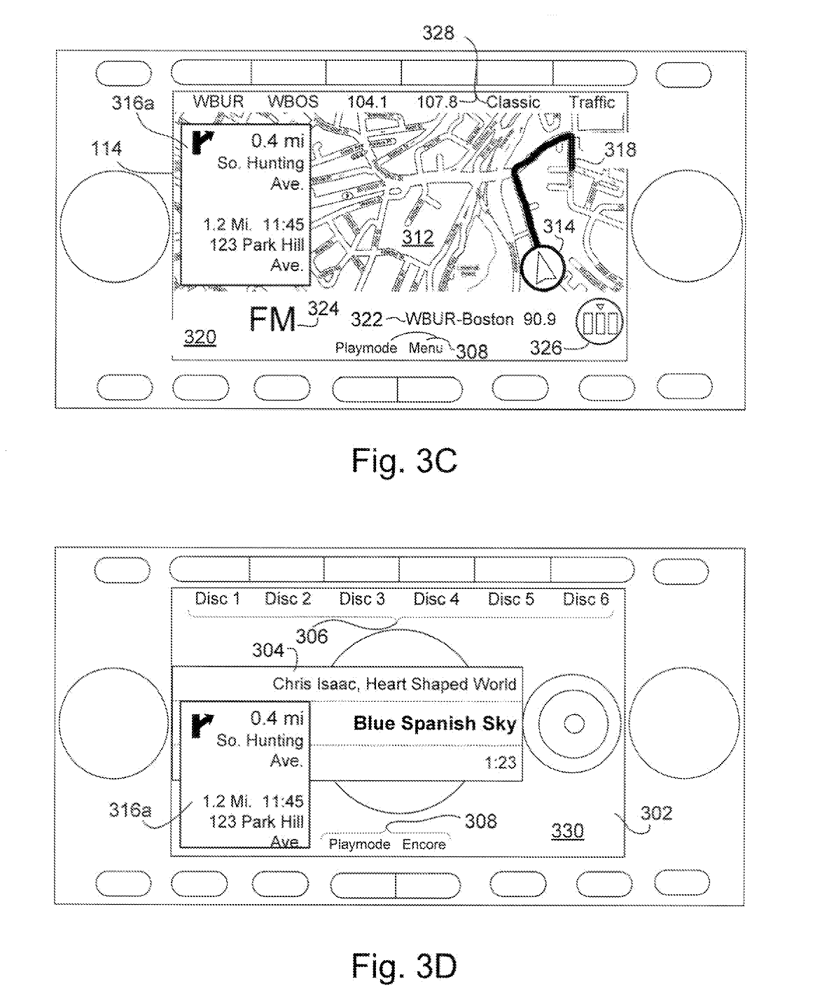

FIGS. 3A-3D are user interfaces of a vehicle entertainment system.

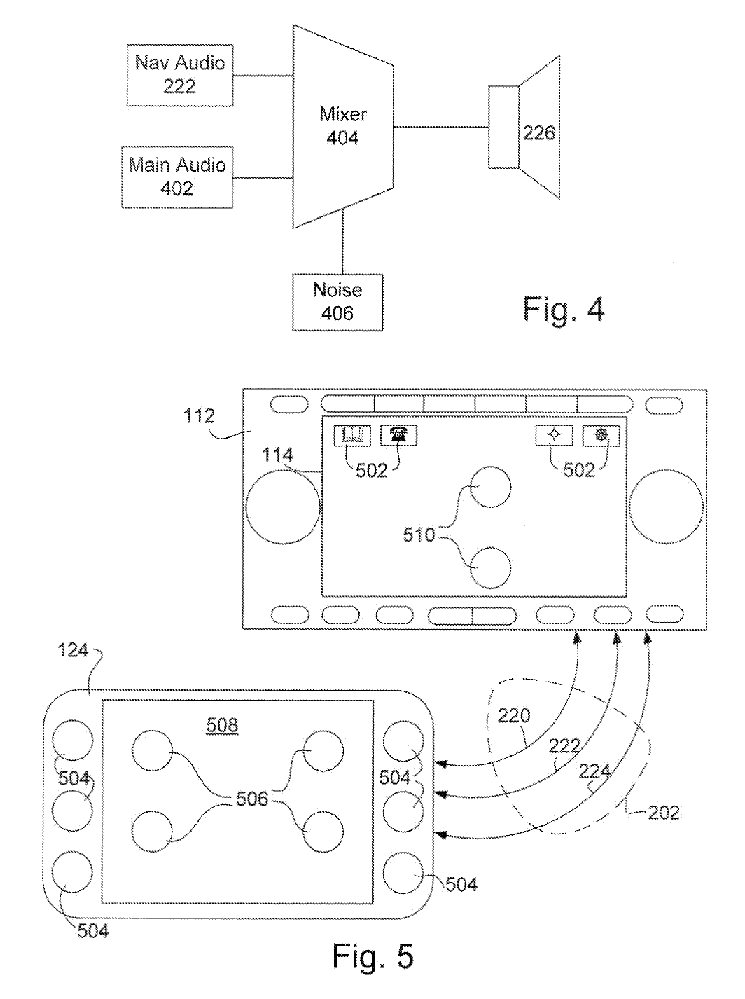

FIG. 4 is a block diagram of an audio mixing circuit.

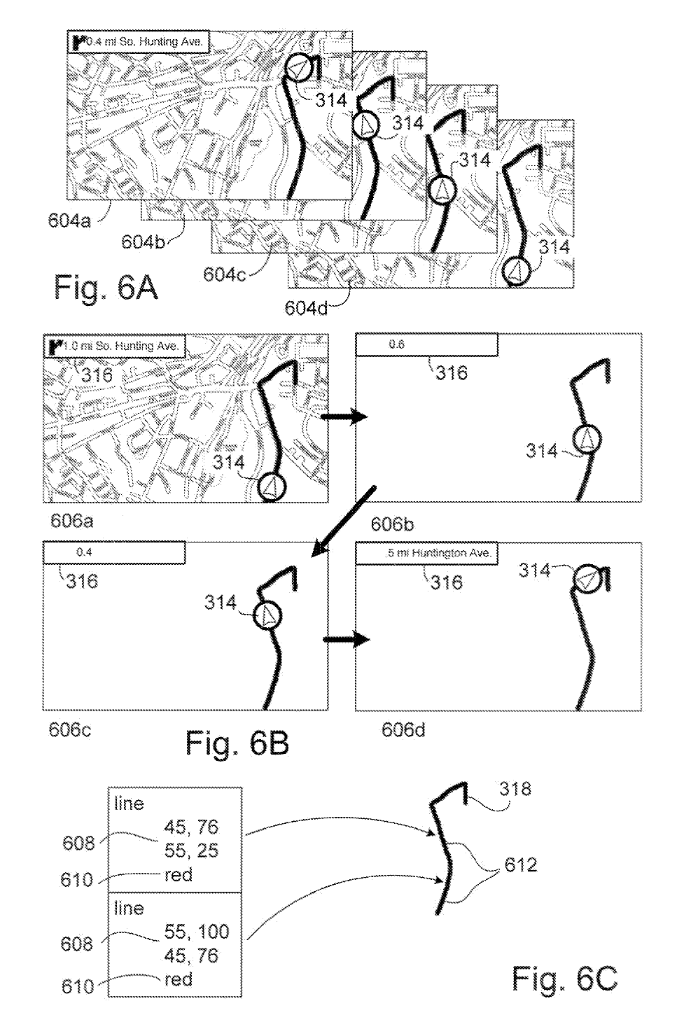

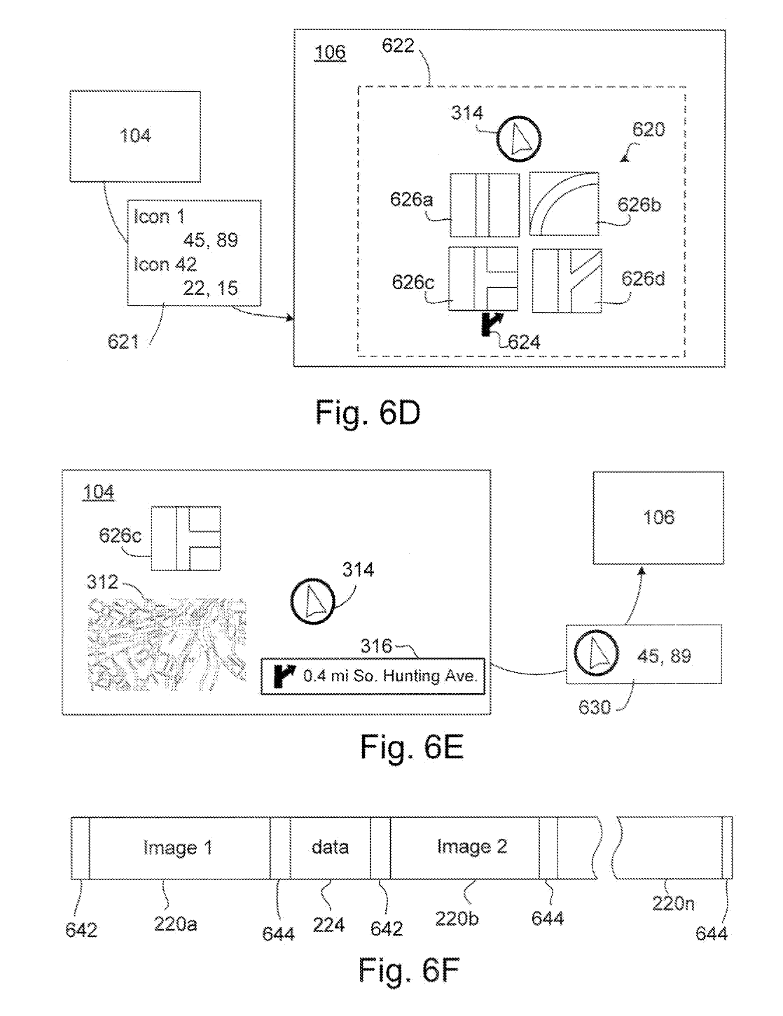

FIGS. 6A-6F are schematic diagrams of processes to update a user interface.

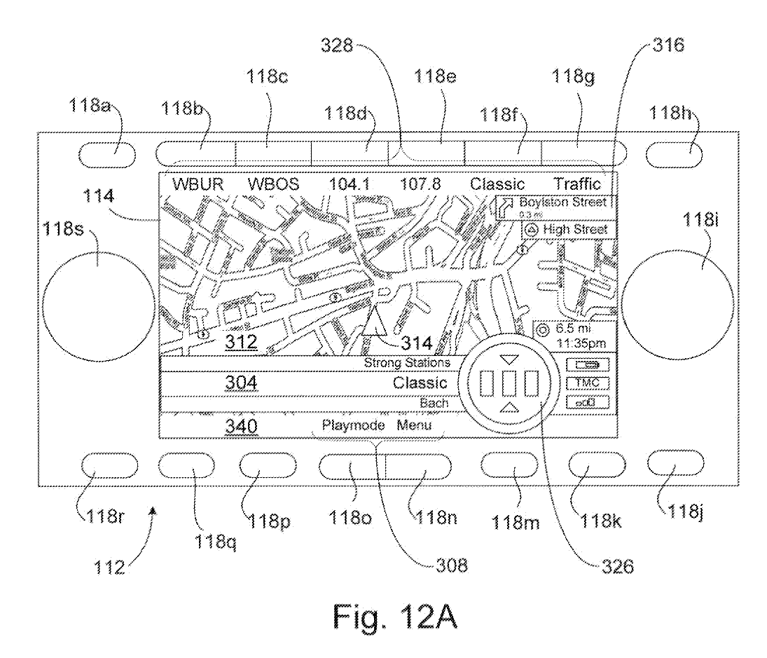

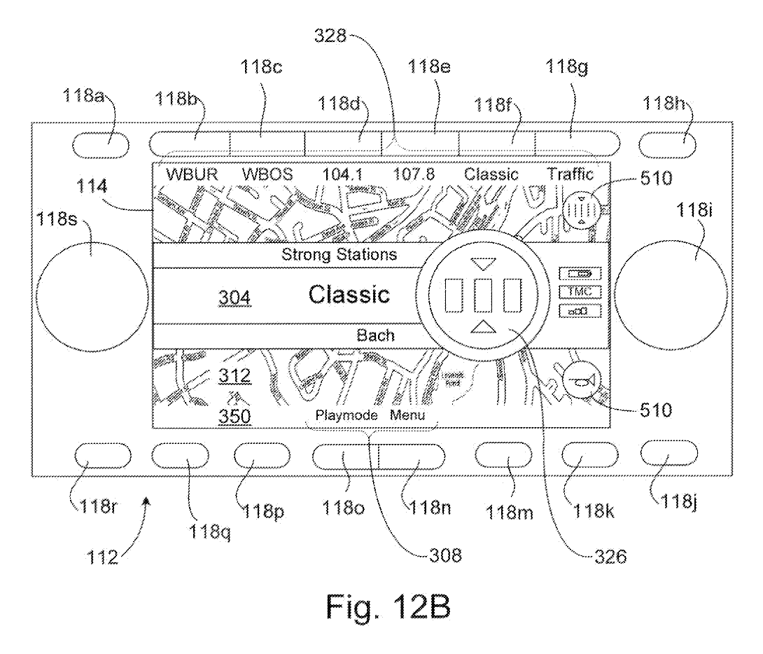

FIGS. 12A-12B are further examples of a vehicle entertainment system.

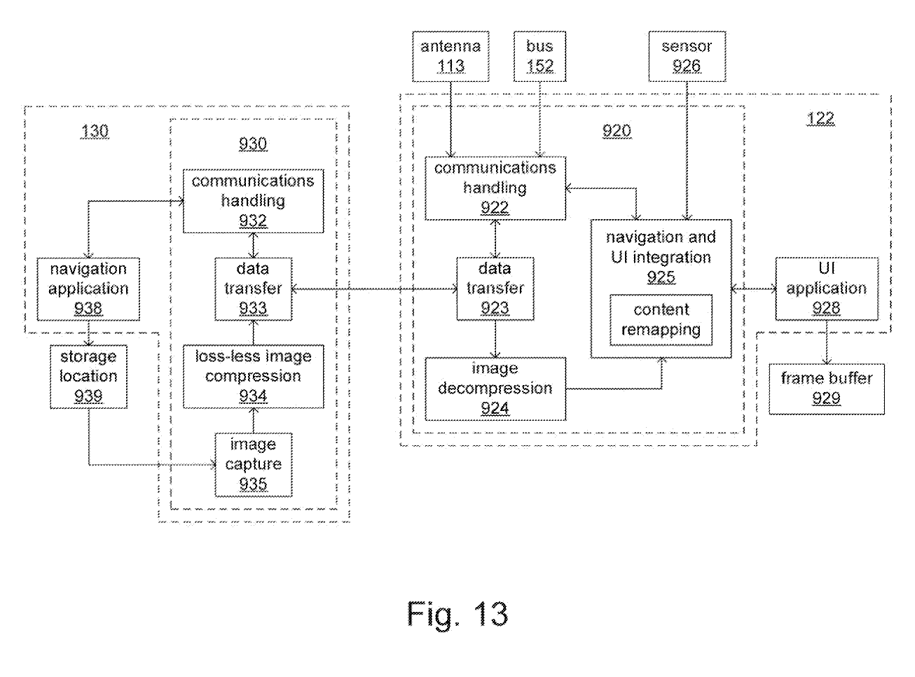

FIG. 13 is a block diagram of portions of software for communication between a vehicle entertainment system and a portable navigation system.

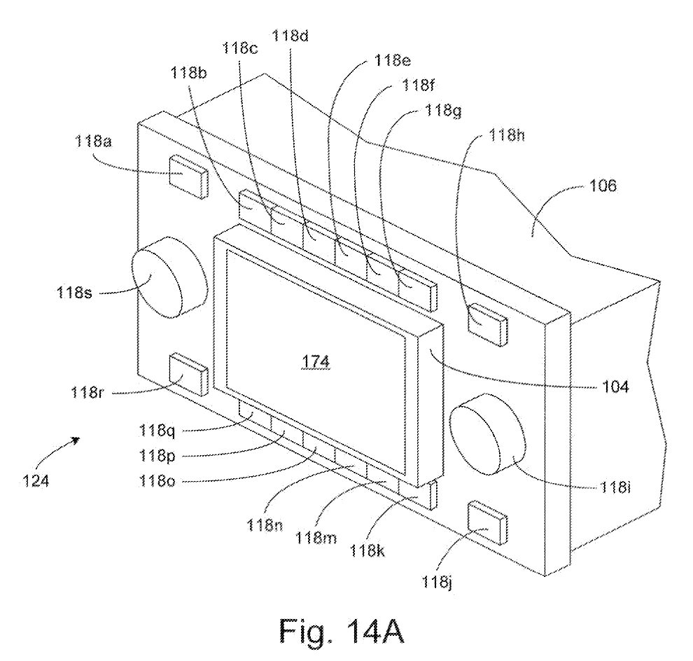

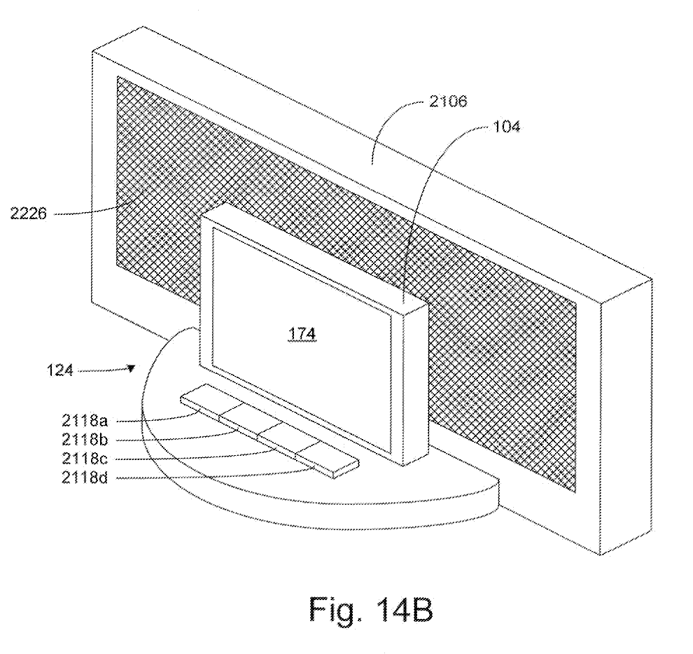

FIG. 14A is a perspective diagram of a vehicle information system.

FIG. 14B is a perspective diagram of a stationary information system.

In-vehicle entertainment systems and portable navigation systems each have unique features that the other generally lacks. One or the other or both can be improved by using capabilities provided by the other. For example, a portable navigation system may have an integrated antenna, which may provide a weaker signal than an external antenna mounted on a roof of a vehicle to be used by the vehicle's entertainment system. In vehicle entertainment systems may lack navigation capabilities or have only limited capabilities. When we refer to a navigation system in this disclosure, we are referring to a portable navigation system separate from any vehicle navigation system that may be built-in to a vehicle. A communications system that can link a portable navigation system with an in-vehicle entertainment system can allow either system to provide services to or receive services shared by the other device.

An in-vehicle entertainment system 102 and a portable navigation system 104 may be linked within a vehicle 100 as shown in FIG. 1A. In some examples, the entertainment system 102 includes a head unit 106, media sources 108, and communications interfaces 110. The navigation system 104 is connected to one or more components of the entertainment system 102 through a wired or wireless connection 101. The media sources 108 and communications interfaces 110 may be integrated into the head unit 106 or may be implemented separately. The communications interfaces may include radio receivers 110a for FM, AM, or satellite radio signals, a cellular interface 110b for two-way communication of voice or data signals, a wireless interface 110c for communicating with other electronic devices such as wireless phones or media players 111, and a vehicle communications interface 110d for receiving data from the vehicle 100. The interface 110c may use, for example, Bluetooth®, WiFi®, or WiMax® wireless technology. References to Bluetooth in the remainder of this description should be taken to refer to Bluetooth or to any other wireless technology or combination of technologies for communication between devices. The communications interfaces 110 may be connected to at least one antenna 113. The head unit 106 also has a user interface 112, which may be a combination of a graphics display screen 114, a touch screen sensor 116, and physical knobs and switches 118, and may include a processor 120 and software 122.

In some examples, the navigation system 104 includes a user interface 124, navigation data 126, a processor 128, navigation software 130, and communications interlaces 132. The communications interface may include GPS, for finding the system's location based on GPS signals from satellites or terrestrial beacons, a cellular interface for transmitting voice or data signals, and a Bluetooth interface for communicating with other electronic devices, such as wireless phones.

In some examples, the various components of the head unit 106 are connected as shown in FIG. 1B. An audio switch 140 receives audio inputs from various sources, including the radio tuner 110a, media sources such as a CD player 108a and an auxiliary input 108b, which may have a jack 142 for receiving input from an external source. The audio switch 140 also receives audio input from the navigation system 104 (not shown) through a connector 160. The audio switch sends a selected audio source to a volume controller 144, which in turn sends the audio to a power amplifier 146 and a loudspeaker 226. Although only one loudspeaker 226 is shown, the vehicle 100 typically has several. In some examples, audio from different sources may be directed to different loudspeakers, e.g., navigation prompts may be sent only to the loudspeaker nearest the driver while an entertainment program continues playing on other loudspeakers. The audio switch 140 and the volume controller 144 are both controlled by the processor 120. The processor receives inputs from the touch screen 116 and buttons 118 and outputs information to the display screen 114, which together form the user interface 112. In some examples, some parts of the interface 112 are physically separate from the other components of the head unit 106.

The processor may receive inputs from individual devices, such as a gyroscope 148 and backup camera 149, and exchanges information with a gateway 150 to an information bus 152 and direct signal inputs from a variety of sources 155, such as vehicle speed sensors or the ignition switch. Whether particular inputs are direct signals or are communicated over the bus 152 will depend on the architecture of the vehicle 100. In some examples, the vehicle is equipped with at least one bus for communicating vehicle operating data between various modules. There may be an additional bus for entertainment system data. The head unit 106 may have access to one or more of these busses. In some examples, a gateway module in the vehicle (not shown) converts data from a bus not available to the head unit 106 to a bus protocol that is available to the head unit 106. In some examples, the head unit 106 is connected to more than one bus and performs the conversion function for other modules in the vehicle. The processor may also exchange data with a wireless interface 159. This can provide connections to media players or wireless telephones, for example. The head unit 106 may also have a wireless telephone interface 110b built-in. Any of the components shown as part of the head unit 106 in FIG. 1B may be integrated into a single unit or may be distributed in one or more separate units. The head unit 106 may use the gyroscope 148 to sense speed, acceleration and rotation (e.g., turning) rather than, or in addition to, receiving such information from the vehicle's sensors. Any of the inputs shown connected to the processor may also be passed on directly to the connector 160, as shown for the backup camera 149.

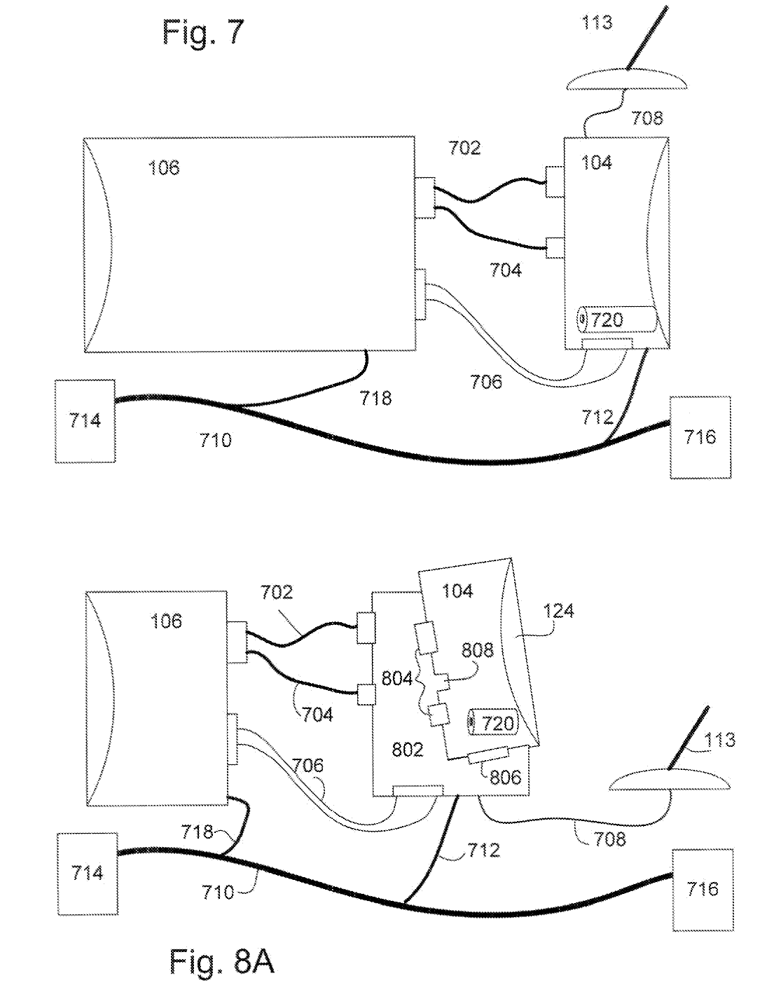

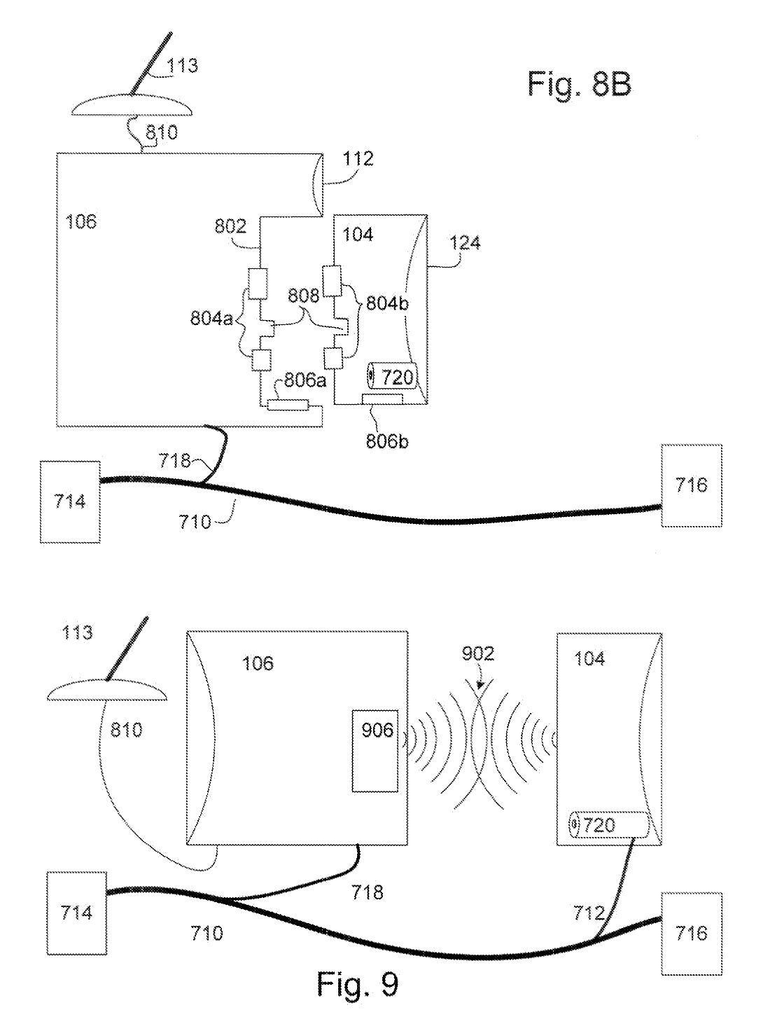

As noted above, in some examples, the connection to the navigation system 104 is wireless, thus the arrows to and from the connector 160 in FIG. 1B would run instead to and from the wireless interface 159. In wired examples, the connector 160 may be a set of standard cable connectors, a customized connector for the navigation system 104 or a combination of connectors, as discussed with regard to FIGS. 7 and 8A, below.

In some examples, the various components of the navigation system 104 are connected as shown in FIG. 1C. The processor 128 receives inputs from communications interfaces including a wireless interface (such as a Bluetooth interface) 132a and a GPS interface 132b, each with its own antenna 134 or a shared common antenna. The wireless interface 132a and GPS interlace 132b may include connections 135 for external antennas or the antennas 134 may be internal to the navigation system 104. The processor 128 also may also transmit and receive data through a connector 162, which mates to the connector 160 of the head unit 106 (in some examples with cables in between, as discussed below). Any of the data communicated between the navigation system 104 and the entertainment system 102 may be communicated though either the connector 162, the wireless interface 132a or both. An internal speaker 168 and microphone 170 are connected to the processor 128. The speaker 168 may be used to output audible navigation instructions, and the microphone 170 may be used for voice recognition. The speaker 168 may also be used to output audio from a wireless connection to a wireless phone using wireless interface 132a. The microphone 170 may also be used to pass to a wireless phone using wireless interface 132a. Audio input and output may also be provided by the entertainment system 102. The audio signals may connect directly through the connector 162 or may pass through the processor 128. The navigation system 104 includes a storage 164 for map data 126, which may be, for example, a hard disk, an optical disc drive or flash memory. This storage 164 may also include recorded voice data to be used in providing the audible instructions output to speaker 168. Software 130 may also be in the storage 164 or may be stored in a dedicated memory.

The connector 162 may be a set of standard cable connectors, a customized connector for the navigation system 104 or a combination of connectors, as discussed with regard to FIGS. 7 and 8A, below.

A graphics processor (GPU) 172 may be used to generate images for display through the user interface 124 or through the entertainment system 102. The GPU 172 may receive video images from the entertainment system 102 directly through the connector 162 or through the processor 128 and process these for display on the navigation system's user interlace 124. Alternatively, video processing could be handled by the main processor 128, and the images may be output through the connector 162 either by the processor 128 or directly by the GPU 172. The processor 128 may also include digital/analog converters (DACs and ADCs) 166, or these functions may be performed by dedicated devices. The user interface 124 may include an LCD or other video display screen 174, a touch screen sensor 176, and controls 178. In some examples, video signals, such as from the backup camera 149, are passed directly to the display 174. A power supply 180 regulates power received from an external source 182 or from an internal battery 720. The power supply 180 may also charge the battery 720 from the external source 182.

In some examples, as shown in FIG. 2, the navigation system 104 can use signals available through the entertainment system 102 to improve the operation of its navigation function. The external antenna 113 on the vehicle 100 may provide a better GPS signal 204a than one integrated into the navigation system 104. Such an antenna 113 may be connected directly to the navigation system 104, as discussed below, or the entertainment system 102 may relay the signals 204a from the antenna after tuning them itself with a tuner 205 to create a new signal 204b, in some examples, the entertainment system 102 may use its own processor 120 in the head unit 106 or elsewhere to interpret signals 204a received by the antenna 113 or signals 204b received from the tuner 205 and relay longitude and latitude data 200 to the navigation system 102. This may also be used when the navigation system 104 requires some amount of time to determine a location from GPS signals after it is activated—the entertainment system 102 may provide a current location to the navigation system 104 as soon as the navigation system 104 is turned on or connected to the vehicle, allowing it to begin providing navigation services without waiting to determine the vehicle's location for itself. Because it is connected to the vehicle 100 through a communications interlace 110d (shown connected to a vehicle information module 207), the entertainment system 102 may also be able to provide the navigation system 104 with data 203 not otherwise available to the navigation system 104, such as vehicle speed 208, acceleration 210, steering inputs 212, and events such as braking 214, airbag deployment 216, or engagement 218 of other safety systems such as traction control, roll-over control, tire pressure monitoring, and anything else that is communicated over the vehicle's communications networks.

The navigation system 104 can use the data 203 for improving its calculation of the vehicle's location, for example, by combining the vehicle's own speed readings 208 with those derived from GPS signals 204a, 204b, or 206, the navigation system 104 can make a more accurate determination of the vehicle's true speed. Signal 206 may also include gyroscope information that has been processed by processor 120 as mentioned above. If a GPS signal 204a, 204b, or 206 is not available, for example, if the vehicle 100 is surrounded by tall buildings or in a tunnel and does not have a line of sight to enough satellites, the speed 208, acceleration 210, steering 212, and other inputs 214 or 218 characterizing the vehicle's motion can be used to estimate the vehicle's course by dead reckoning. Gyroscope information that has been processed by processor 120 and is provided by 206 may also be used. In some examples, the computations of the vehicle's location based on information other than GPS signals may be performed by the processor 120 and relayed to the navigation system in the form of a longitude and latitude location. If the vehicle has its own built-in navigation system, such calculations of vehicle location may also be used by that system. Other data 218 from the entertainment system of use to the navigation system may include traffic data received through the radio or wireless phone interface, collision data, and vehicle status such as doors opening or closing, engine start, headlights or internal lights turned on, and audio volume. This can be used for such things as changing the display of the navigation device to compensate for ambient light, locking-down the user interface during while driving, or calling for emergency services in the event of an accident if the car does not have its own wireless phone interface.

The navigation system 104 may also provide services through the entertainment system 102 by exchanging data including video signals 220, audio signals 222, and commands or information 224, collectively referred to as data 202. Power for the navigation system 104, for charging or regular use, may be provided from the entertainment system's power supply 156 to the navigation, system's power supply 180 through connection 225. If the navigation system's communications interfaces 132 include a wireless phone interface 132a and the entertainment system 102 does not have one, the navigation system 104 may citable the entertainment system 102 to provide hands-free calling to the driver through, the vehicle's speakers 226 and a microphone 230. The audio signals 222 carry the voice from the driver to the wireless phone interface 132a in the navigation system and carry any audio from a call back to the entertainment system 202. The audio signals 222 can also be used to transfer audible instructions such as driving directions or voice recognition acknowledgements from the navigation system 104 to the head unit 106 for playback on the vehicle's speakers 226 instead, of using a built-in speaker 168 in the navigation system 104.

The audio signals 222 may also be used to provide hands-free operation from one device to another. If the entertainment system 102 has a hands-free system 222, it may receive voice inputs and relay them as audio signals 222 to the navigation system 104 for interpretation by voice recognition software and receive audio responses 222, command data and display information 224, and updated graphics 220 back from the navigation system 104. The entertainment system 102 may also interpret the voice inputs itself and send control commands 224 directly to the navigation system 204. If the navigation system 104 has a hands-free system 236 capable of controlling aspects of the entertainment system, the entertainment system may receive audio signals from its own microphone 230, relay them as audio signals 222 to the navigation system 104 for interpretation, and receive control commands 224 and audio responses 222 back from the navigation system 104. In some examples, the navigation system 104 also functions as a personal media player, and the audio signals 222 may carry a primary audio program to be played back through the vehicle's speakers 226.

If the head unit 106 has a better screen 114 than the navigation system 104 has (for example, it may be larger, brighter, or located where the driver can see it more easily), video signals 220 can allow the navigation system 104 to display its user interface 124 through the head unit 106's screen 114. The head unit 106 can receive inputs on its user interface 116 or 118 and relay these to the navigation system 104 as commands 224. In this way, the driver only needs to interact with one device, and connecting the navigation system 104 to the entertainment system 102 allows the entertainment system 102 to operate as if it included navigation features. In some examples, the navigation system 104 may be used to display images from the entertainment system 102, for example, from the backup camera 149 or in place of using the head unit's own screen 114. Such images can be passed to the navigation system 104 using the video signals 220. This has the advantage of providing a graphical display screen for a head unit 106 that may have a more-limited display 114. For example, images from the backup camera 149 may be relayed to the navigation system 104 using video signals 220, and when the vehicle Is put in to reverse, as indicated by a direct input 154 or over the vehicle bus 152 (FIG. 1B), this can be communicated to the navigation system 104 using the command and information link 224. At this point, the navigation system 104 can automatically display the backup camera's images. This can be advantageous when the navigation system 104 has a better or move-visible screen 174 than the head unit 106 has, giving the driver the best possible view.

In cases where the entertainment system 102 does include navigation features, the navigation system 104 may be able to supplement or improve on those features, for example, by providing more-detailed or more-current maps though the command and information link 224 or offering better navigation software or a more powerful processor. In some examples, the head unit 106 may be equipped to transmit navigation service requests over the command and information link 224 and receive responses from the navigation system's processor 128. In some examples, the navigation system 104 can supply software 130 and data 126 to the head unit 106 to use with its own processor 120. In some examples, the entertainment system 102 may download additional software to the personal navigation system, for example, to update its ability to calculate location based on the specific information that vehicle makes available.

The ability to relay the navigation system's interlaces through the entertainment system has the benefit of allowing the navigation system 104 to be located somewhere not readily visible to the driver and to still provide navigation and other services. The connections described may be made using a standardized communications interlace or may be proprietary. A standardized interface may allow navigation systems from various manufacturers to work in a vehicle without requiring customization. If the navigation systems use proprietary formats for data, signals, or connections, the entertainment system 102 may include software or hardware that allows it to convert between formats as required.

In some examples, the navigation system's interface 124 is relayed through the head unit's interface 112 as shown in FIGS. 3A-3D. In this example, the user interlace 112 includes a screen 114 surrounded by buttons and knobs 118a-118s. Initially, as shown in FIG. 3A, the screen 114 shows an image 302 unrelated to navigation, such as an identification 304 and status 305 of a song currently playing on the CD player 108a. Other information 306 indicates what data is on CDs selectable by pressing buttons 118b-118h and other functions 308 available through buttons 118n and 118o. Pressing a navigation button 118m causes the screen 114 to show an image 310 generated by the navigation system 104, as shown in FIG. 3B. This image includes a map 312, the vehicle's current location 314, the next step of directions 316, and a line 318 showing the intended path. This image 310 may be generated completely by the navigation system 104 or by the head unit 106 as instructed by the navigation system 104, or a combination of the two. Each of these methods is discussed below.

In the example of FIG. 3C, a screen 320 combines elements of the navigation screen 310 with elements related to other functions of the entertainment system 102. In this example, an indication 322 of what station is being played, the radio hand 324, and an icon 326 indicating the current radio mode use the bottom of the screen, together with function indicators 308 and other radio stations 328 displayed at the top, with the map 312, location indicator 314, a modified version 316a of the directions, and path 318 in the middle. The directions 316a may also include point of interest information, such as nearby gas stations or restaurants, the vehicle's latitude and longitude, current street name, distance to final destination, time to final destination, and subsequent or upcoming driving instructions such as “in 0.4 miles, turn right onto So. Hunting Ave.”

In the example of FIG. 3D, a screen image 330 includes the image 302 for the radio with the next portion of the driving directions 316 from the navigation system overlaid, for example, in one corner. Such a screen may be displayed, for example, if the user wishes to adjust the radio while continuing to receive directions from the navigation system 104, to avoid missing a turn. Once the user has selected a station, the screen may return to the screen 320 primarily showing the map 312 and directions 316.

Audio from the navigation system 104 and entertainment system 102 may similarly be combined, as shown in FIG. 4. The navigation system may generate occasional audio signals, such as a voice prompts telling the driver about an upcoming turn, which are communicated to the entertainment system 102 through audio signals 222 as described above. At the same time, while the entertainment system 102 is likely to generate continuous audio signals 402, such as music from the radio or a CD. In some examples, a mixer 404 in the head unit 106 determines which audio source should take priority and directs that one to speakers 226. For example, when a turn is coming up and the navigation system 104 sends an announcement over audio signals 222, the mixer may reduce the volume of music and play the turn instructions at a relatively loud volume, if the entertainment system is receiving vehicle information 203, it may also base the volume on factors 406 that may cause ambient noise, e.g., increasing the volume to overcome road noise based on foe vehicle speed 208. In some examples, the entertainment system may include a microphone to directly discover noise levels 406 and compensate for them either by raising the volume or by actively canceling the noise. The audio from the lower-priority source may be silenced completely or may only be reduced in volume and mixed with the louder high-priority audio. The mixer 404 may be an actual hardware component or may be a function carried out by the processor 120.

When the head unit's interface 112 is used in this manner as a proxy for the navigation system's interface 124, in addition to using the screen 114, it may also use the head unit's inputs 118 or touch screen 116 to control the navigation system 104. In some examples, as shown in FIGS. 3A-3D, some buttons on the head unit 106 may not have dedicated functions, but instead have context-sensitive functions that are indicated on the screen 114. Such buttons or knobs 118i and 118s can be used to control the navigation system 104 by displaying relevant features 502 on the screen 114, as shown in FIG. 5. These might correspond to physical buttons 504 on the navigation system 104 or they might correspond to controls 506 on a touch-screen 508. If the head unit's interface 112 includes a touch screen 116, it could simply be mapped directly to the touch screen 506 of the navigation system 104 or it could display virtual buttons 510 that correspond to the physical buttons 504. The amount and types of controls displayed on the screen 114 may be determined by the specific data sent from the navigation system 104 to the entertainment system 102. For example, if point of information data is sent, then one of the virtual buttons 510 may represent the nearest point of information, and if the user selects it, additional information may be displayed.

Several methods can be used to generate the screen images shown on the screen 114 of the head unit 106. In some examples, as shown In FIGS. 6A-6C, a video image 602 is transmitted from the navigation system 104 to the head unit 106. This image 602 could be transmitted as a data file using an image format like BMP, JPEG or PNG or it may be streamed as an image signal over a connection such as DVI or Firewire or analog alternatives like RBG. The head unit 106 may decode the signal 604 and deliver it directly to the screen 114 or it may filter it, for example, upscaling, downscaling, or cropping to accommodate the resolution of the screen 114. The head unit may combine part of or the complete image 602 with screen image elements generated by the head unit itself or other accessory devices to generate mixed images like those shown in FIGS. 3C and 3D.

The image may be provided by the navigation system in several forms including a full image map, difference data, or vector data. For a full image map, as shown in FIG. 6A, each frame 604a-604d of image data contains a complete image. For difference data, as shown in FIG. 6B, a first frame 606a includes a complete image, and subsequent frames 606b-606d only Indicate changes to the first frame 606a (note moving indicator 314 and changing directions 316). Vector data, as shown in FIG. 6C, provides a set of instructions that tell the processor 120 how to draw the image, e.g., instead of a set of points to draw the line 318, vector data includes an identification 608 of the end points of segments 612 of the line 318 and an instruction 610 to draw a line between them.

The image may also be transmitted as icon data, as shown in FIG. 60, in which the head unit 106 maintains a library 622 of images 620 and the navigation system 104 provides instructions of which images to combine to form the desired display image. Storing the images 620 in the head unit 106 allows the navigation system 104 to simply specify 621 which elements to display. This can allow the navigation system 104 to communicate the images it wishes the head unit 106 to display using less bandwidth than may be required for a full video image 602. Storing the images 620 in the head unit 106 may also allow the maker of the head unit to dictate the appearance of the display, for example, maintaining a branded look-and-feel different from that used by the navigation system 104 on its own interface 124. The pre-arranged image elements 620 may Include icons like the vehicle location icon 314, driving direction symbols 624, or standard map elements 626 such as straight road segments 626a, curves 626b, and intersections 626e, 626d. Using such a library of image elements may require some coordination between the maker of the navigation system 104 and the maker of the head unit 106 in the ease where the manufacturers are different, but could be standardized to allow interoperability. Such a technique may also be used with the audio navigation prompts discussed above—pre-recorded messages such as “turn left in 100 yards” may be stored in the head unit 106 and selected for playback by the navigation system 104.

In a similar fashion, as shown in FIG. 6E, the Individual screen elements 620 may be transmitted from the navigation system 104 with instructions 630 on how they may be combined. In this case, the elements may include specific versions such as actual maps 312 and specific directions 316, such as street names and distance indications, that would, be less likely to be stored in a standardized library 622 in the head unit 106. Either approach may simplify generating mixed-mode screen images like screen images 320 and 330, because the head unit 106 does not have to analyze a full image 602 to determine which portion to display.

When an image is being transmitted from the navigation system 104 to the head unit 106, the amount of bandwidth required may dominate the connections between the devices. For example, if a single USB connection is used for the video signals 220, audio signals 222, and commands and information 224, a full video stream may not leave any room for control data. In some examples, as shown in FIG. 6F, this can be addressed by dividing the video signals 220 into blocks 220a, 220b, . . . 220n and interleaving blocks of commands and information 224 in between them. This can allow high priority data like control inputs to generate interrupts that assure they get through. Special headers 642 and footers 644 may be added to the video blocks 220a-220n to indicate the start or end of frames, sequences of frames, or full transmissions. Other approaches may also be used to transmit simultaneous video, audio, and data, depending on the medium used.

In some examples, the navigation system 104 may be connected to the entertainment system 102 through a direct wire connection as shown in FIG. 7, by a docking unit, as shown in FIGS. 8A and 8B, or wirelessly, as shown in FIG. 9.

FIGS. 12A-B depict examples of the user interface 112 displaying visual elements pertaining to the navigation function performed by the portable navigation system 104 on the screen 114 in one layer and displaying visual elements pertaining to entertainment in an overlying layer. This layering of visual elements pertaining to entertainment over visual elements pertaining to navigation enables the relative prominence of the visual elements of each of these two functions to be quickly changed as will be explained. The portable navigation system 104 and the head unit 106 interact in a manner that causes visual elements provided by the portable navigation system 104 to be displayed on the screen 114 through the user interface 112, and a user of the head unit 106 is able to Interact with the navigation function of the navigation system 104 through the user Interface 112. Visual elements pertaining to entertainment are also displayed on the screen 114 through the user interface 112, and the user is also able to interact with the entertainment function through the user interface 112.

As shown in FIG. 12A, the screen 114 shows an image 340 combining aspects of both navigation and entertainment functions. The navigation portion of the image 340 is at least partially made up of a map 312 that may be accompanied with a location indicator 314 and/or a next step of directions 316. The entertainment portion of the image 340 is at least partially made up of an identification 304 of a currently playing song and an icon 326 indicating the current radio mode, and these may be accompanied by other information 328 indicating various radio stations selectable by pressing buttons 118b-118h and/or other functions 308 selectable through buttons 118n and 118o. As can be seen, in the image 340, the display of the navigation function is intended to be more dominant (e.g., occupying more of the screen 114) man the display of the entertainment function. A considerable amount of the viewable area of the screen 114 is devoted to the map 312, and a relatively minimal portion of the map 312 is overlain by the identification 304 and the icon 326.

FIG. 12B depicts one possible response that may be provided by the user interlace 112 to a user of the head unit 106 extending their hand towards the head unit 106. In some embodiments, the head unit 106 incorporates a proximity sensor (not shown) that detects the approach of the user's extended hand. Alternatively, the depicted response could be to an actuation of one of the buttons and knobs 118a-118s by the user. As depicted, this response could entail changing the manner in which navigation and entertainment functions are displayed by the user interface 112 such that an, image 350 is displayed on the screen 114 in which the display of the entertainment function is made more dominant than the display of the navigation function. By way of example as depicted in FIG. 12B, the identification 304 and the icon 326 may both be enlarged and/or positioned at a more central location overlying the map 312 on the screen 114 relative to their size and/or position in FIG. 12A. Furthermore, the next step of directions 316 (FIG. 12A) may be removed from view and/or virtual buttons 510 pertaining to the entertainment function may be prominently displayed such that they also overly the map 312. Such dominance of the entertainment function in response to the detection of the proximity of the user's hand could be caused, in one embodiment, to occur based on an assumption that the user is more likely to be intent upon interacting with the entertainment function than the navigation function. In some embodiments, this response may be automatically disabled by the occurrence of a condition that may be taken to negate the aforementioned assumption, such as the vehicle in which the head unit 106 is installed being put into “park” based on the assumption that the user is more likely to take that opportunity to specify a new destination. In alternative embodiments, the user may be provided with the ability to disable this response.

Either a hardware-based or a software-based implementation of layering may be used. In a software-based implementation, the processor 120 (FIG. 1B), is caused by software implementing the user interface 112 to perform layering by providing only portions of the visual elements pertaining to the navigation function that are not overlain by portions of the visual elements pertaining to the entertainment function to be displayed on the screen 114, and causing visual elements pertaining to the entertainment function to be displayed in their overlying locations on the screen 114. Alternatively, a graphics processing unit (not shown) of the head unit 106 may perform at least part of this layering in lieu of the processor 120. In a hardware-based implementation, a pixel-for-pixel hardware map of which layer is to be displayed at each pixel of the screen 114 may be employed, and at least one visual element pertaining to entertainment may be stored in a dedicated storage device (not shown), such as a hardware-based sprite. As bitmaps, vector scripts, color mappings and/or other forms of data pertaining to the appearance of one or more of visual elements of the navigation function are received by the head unit 106 from the portable navigation system 104, various indexing and/or addressing algorithms may he employed to cause visual elements pertaining to the navigation function to be stored separately or differently from the visual elements pertaining to the entertainment function.

Differences in how a given piece of data is displayed on the screen 174 and how it is displayed on the screen 114 may dictate whether that piece of data is transmitted by the portable navigation system 104 to the head unit 106 as visual data or as some other form of data, and may dictate the form of visual data used where the given piece of data is transmitted as visual data. By way of example and solely for purposes of discussion, when the portable navigation system 104 is used by itself and separately from the head unit 106, the portable navigation system 104 may display the current time on the screen 174 of the portable navigation system 104 as part of performing its navigation function. However, when the portable navigation system 104 is then used in conjunction with the bead unit 106 as has been described herein, the portable navigation system 104 may transmit the current time to the head unit 106 to be displayed on the screen 114. This transmission, of the current time may be performed either by transmitting the current time as one or more values representing the current time, or by transmitting a visual element that provides a visual representation of the current time such as a bitmap of human-readable digits or an analog clock face with hour and minute hands. In some embodiments, where the screen 114 is larger or in some other way superior to the screen 174, what is displayed on the screen 114 may differ from what would be displayed on the screen 174 in order to make use of the superior features of the screen 114. In some cases, even though the current time may be displayed on the screen 174 as part of a larger bitmap of other navigation input data, it may be desirable to remove that display of the current time from that bitmap, and instead, transmit the time as one or more numerical or other values that represent the current time to allow the head unit 106 to display that bitmap without the inclusion of the current time. This would also allow the head unit 106 to either employ those value(s) representing the current time in generating a display of the current time that is in some way different from that provided by the portable navigation unit 104, or would allow the head unit to refrain from displaying the current time, altogether. Alternatively, it may be advantageous to simply transfer a visual element providing a visual representation of the current time as it would otherwise be displayed on the screen 174 for display on the screen 114, but separate from other visual elements to allow flexibility in positioning the display of the current time on the screen 114. Those skilled in the art will readily recognize that although this discussion has centered on displaying the current time, it is meant as an example, and this same choice of whether to convey a piece of data as a visual representation or as one or more values representing the data may be made regarding any of numerous other pieces of information provided by the portable navigation device 104 to the head unit 106.

As previously discussed with regard to FIGS. 3A-D, the various buttons and knobs 118a-s may be used as a proxy for buttons or knobs of the portable navigation system 104 and/or for virtual controls displayed as part of the touchscreen functionality provided by the screen 174 and the touchscreen sensor 176 of the portable navigation system 104. Given that one or more of the buttons and knobs 118a-s may be used as a proxy in place of one or more virtual controls displayed on the screen 174, it may be desirable to remove the image of such controls from one or more images transmitted from the portable navigation device 104 to the head unit 106. It is further possible that the determination of which control of the portable navigation system 104 is to be replaced by which of the buttons and knobs 118a-s as a proxy may be made dynamically in response to changing conditions. For example, it is possible that the portable navigation system 104 may be used with two or different versions of the head unit 106 (e.g., a user with more than one vehicle having a version of the head unit 106 installed therein) where one of the two versions provides one or more buttons or knobs that the other version does not. The version with the greater quantity of buttons or knobs would enable more of the controls of the portable navigation system 104 to be replaced with buttons or knobs in a proxy role than the other version. When the portable navigation system 104 is used with the other version, more of the controls may have to he presented to the user as virtual controls on the screen 114.

FIG. 13 depicts one possible implementation of software-based interaction between the portable navigation device 104 and the head unit 106 that allows images made up of visual elements provided by the portable navigation system 104 to be displayed on the screen 114, and that allows a user of the head unit 106 to interact with the navigation function of the portable navigation system 104. The display of images and the interactions that may be supported by this possible implementation may include those discussed with regard to any of FIGS. 3A-D, FIGS. 6A-F, and/or FIGS. 12A-B.

As earlier discussed, the head unit 106 incorporates software 122. A portion of the software 122 of the head unit 106 is a user interface application 928 that causes the processor 120 to provide the user interface 112 through which the user interacts with the head unit 106. Another portion of the software 122 is software 920 that causes the processor 120 to interact with the portable navigation device 104 to provide the portable navigation device 104 with navigation input data and to receive visual and other data pertaining to navigation for display on the screen 114 to the user. Software 920 includes a communications handling portion 922, a data transfer portion 923, an image decompression portion 924, and a navigation and user interface (UI) integration portion 925.

As also earlier discussed, the portable navigation system 104 incorporates software 130. A portion of the software 130 is software 930 that causes the processor 128 to interact with the head unit 106 to receive the navigation input data and to provide visual elements and other data pertaining to navigation to the head unit 106 for display on the screen 114. Another portion of the software 130 of the portable navigation system 104 is a navigation application 938 that causes the processor 128 to generate those visual elements and other data pertaining to navigation from the navigation input data received from the head unit 106. Software 930 includes a communications handling portion 932, a data transfer portion 933, a loss-less image compression portion 934, and an image capture portion 935.

As previously discussed, each of the portable navigation system 104 and the head unit 106 are able to be operated entirely separately of each other. In some embodiments, the portable navigation system 104 may not have the software 930 installed and/or the head unit 106 may not have the software 920 installed. In such cases, it would be necessary to install one or both of software 920 and the software 930 to enable the portable navigation system 104 and the head unit 106 to interact.

In the interactions between the head unit 106 and the portable navigation system 104 to provide a combined display of imagery for both navigation and entertainment, the processor 120 is caused by the communications handling portion 922 to assemble GPS data received from satellites (perhaps, via the antenna 113 in some embodiments) and/or other location data from vehicle sensors (perhaps, via the bus 152 in some embodiments) to assemble navigation input data for transmission to the portable navigation system 104. As has been explained earlier, the head unit 106 may transmit what is received from satellites to the portable navigation system 104 with little or no processing, thereby allowing the portable navigation system 104 to perform most or all of this processing as part of determining a current location. However, as was also explained earlier, the head unit 106 may perform at least some level of processing on what is received from satellites, and perhaps provide the portable navigation unit 104 with coordinates derived from that processing denoting a current location, thereby freeing the portable navigation unit 104 to perform other navigation-related functions. Therefore, the GPS data assembled by the communications handling portion 922 into navigation input data may have already been processed to some degree by the processor 120, and may be GPS coordinates or may be even more thoroughly processed GPS data. The data transfer portion 923 then causes the processor 120 to transmit the results of this processing to the portable navigation system 104. Depending on the nature of the connection, established between the portable navigation device and the head unit 106 (i.e., whether that connection is wireless (including the use of either infrared or radio frequencies) or wired, electrical or fiber optic, serial or parallel, a connection shared among still other devices or a point-to-point connection, etc.), the data transfer portion 923 may serialize and/or packetize data, may embed status and/or control protocols, and/or may perform, various other functions required by the nature of the connection.

Also in the interactions between the head unit 106 and the portable navigation system 104, the processor 120 is caused by the navigation and user interface (UI) integration portion 925 to relay control inputs received from the user interface (UI) application 928 as a result of a user actuating controls or taking other actions that necessitate the sending of commands to the portable navigation system 104. The navigation and UI integration portion relays those control inputs and commands to the communications handling portion 922 to be assembled for passing to the data transfer portion 923 for transmission to the portable navigation system 104.

The data transfer portion 933 causes the processor 128 to receive the navigation input data and the assembled commands and control inputs transferred to the portable navigation device 104 as a result of the processor 120 executing a sequence of the instructions of the data transfer portion 923. The processor 128 is further caused by the communications handling portion 932 to perform some degree of processing on the received navigation input data and the assembled commands and control inputs. In some embodiments, this processing may be little more than reorganizing the navigation input data and/or the assembled commands and control inputs. Also, in some embodiments, this processing may entail performing a sampling algorithm to extract data occurring at specific time intervals from other data.

The processor 128 is then caused by the navigation application 938 to process the navigation input data and to act on the commands and control inputs. As part of this processing, the navigation application 938 causes the processor 128 to generate visual elements pertaining to navigation and to store those visual elements in a storage location 939 defined within storage 164 and/or within another storage device of the portable navigation device 104. In some embodiments, the storage of the visual elements may entail the use of a frame buffer defined through the navigation application 938 in which at least a majority of the visual elements are assembled together in a substantially complete image to be transmitted to the head unit 106. It may be that the navigation application 938 routinely causes the processor 128 to define and use a frame buffer as part of enabling visual navigation elements pertaining to navigation to be combined in the frame buffer for display on the screen 174 of the portable navigation system 104 when the portable navigation system 104 is used separately from the head unit 106. It may be that the navigation application continues to cause the processor 12S to define and use a frame buffer when the image created in the frame buffer is to be transmitted to the head unit 106 for display on the screen 114. Those skilled in the art of graphics systems will recognize that such a frame buffer may be referred to as a “virtual” frame butter as a result of such a frame buffer not being used to drive the screen 174, but instead, being used to drive the more remote screen 114. In alternate embodiments, at least some of the visual elements may be stored and transmitted to the head unit 106 separately from each other. Those skilled in the art of graphics systems will readily appreciate that visual elements may be stored in any of a number of ways.

Where the screen 114 of the head unit 106 is larger or has a greater pixel resolution than the screen 174 of the portable navigation system 104, one or more of the visual elements pertaining to navigation may be displayed on the screen 114 in larger size or with greater detail than would be the case when displayed on the screen 174. For example, where the screen 114 has a higher resolution, the map 312 may be expanded to show more detail such as streets, when created for display on the screen 114 versus the screen 174. As a result, where a frame buffer is defined and used by the navigation application 938, that frame buffer may be defined to be of a greater resolution when its contents are displayed on the screen 114 than when displayed on the screen 174.

Regardless of how exactly the processor 128 is caused by the navigation application 938 to store visual elements pertaining to navigation, the image capture portion 935 causes the processor 128 to retrieve those visual elements for transmission to the head unit 106. As those skilled in the art of graphics systems will readily recognize, where a repeatedly updated frame buffer is defined and/or where a repeatedly updated visual element is stored as a bitmap (for example, perhaps the map 312), there may be a need to coordinate the retrieval of either of these with their being updated. Undesirable visual artifacts may occur where such updating and retrieval are not coordinated, including instances where either a frame buffer or a bitmap is displayed in a partially updated state. In some embodiments, the updating and retrieval functions caused to occur by the navigation application 938 and the image capture portion 935, respectively, may be coordinated through various known handshaking algorithms involving the setting and monitoring of various flags between the navigation application 938 and the image capture portion 935.

However, in other embodiments, where the navigation application 938 was never written to coordinate with the image capture portion 935, the image capture portion 935 may cause the processor 128 to retrieve a frame buffer or a visual element on a regular basis and to monitor the content of such a frame buffer or visual element for an indication that the content has remained sufficiently unchanged that what was retrieved may he transmitted to the head unit 106. More specifically, the image capture portion 935 may cause the processor 128 to repeatedly retrieve the content of a frame buffer or a visual element and compare every Nth horizontal line (e.g., every 4th horizontal line) with those same lines from the last retrieval to determine if the content of any of those lines has changed, and if not, then to transmit the most recently retrieved content of that frame buffer or visual element to the head unit 106 for display. Such situations may arise where the software 930 is added to the portable navigation system 104 to enable the portable navigation system 104 to interact with the head unit 106, but such an interaction between the portable navigation system 104 and the head unit 106 was never originally contemplated by the purveyors of the portable navigation system 104.

The loss-less image compression portion 934 causes the processor 128 to employ any of a number of possible compression algorithms to reduce the size of what the image capture portion 935 has caused the processor 128 to retrieve In order to reduce the bandwidth requirements for transmission to the head unit 106. This may be necessary where the nature of the connection between the portable navigation system 104 and the head unit 106 is such that bandwidth is too limited to transmit an uncompressed frame buffer and/or a visual, element (e.g., a serial connection such as EIA RS-232 or RS-422), and/or where it is anticipated that the connection will be used to transfer a sufficient amount of other data that bandwidth for those transfers must remain available.

Such a limitation in the connection may be addressed through the use of data compression, however, as a result of efforts to minimise costs in the design of typical portable navigation systems, there may not be sufficient processor or storage capacity available to use complex compression algorithms such as JPEG, etc. In such cases, a simpler compression algorithm may be used in which a frame buffer or a visual element stored as a bitmap may be transmitted by serializing each horizontal line and creating a description of the pixels in the resulting pixel stream in which pixel color values are specified only where they change and those pixel values are accompanied by a value describing how many adjacent pixels in the stream have the same color. Also, in such embodiments where the actual quantity of colors is limited, color lookup tables may be employed to reduce the number of bytes required to specify each color. The compressed data is then caused to be transmitted by the processor 128 to the head unit 106 by the data transfer portion 933.

The processing of the navigation input data and both the commands and control inputs caused by the navigation application 938 also causes the processor 128 to generate navigation output data. The navigation output data may include numerical values and/or various other indicators of current location, current compass heading, or other current navigational data that is meant to be transmitted back to the head unit 106 in a form other than that of one or more visual elements. It should be noted that such navigation output data may be transmitted to the head unit 106 either in response to the receipt of the commands and/or control inputs, or without such solicitation from the head unit 106 (e.g., as part of regular updating of information at predetermined intervals). Such navigation output data is relayed to the communications handling portion 932 to be assembled to then be relayed to the data transfer portion 933 for transmission back to the head unit 106.

The data transfer portion 923 and the image decompression portion 924 Causes the processor 120 of the head unit 106 to receive and decompress, respectively, what was caused to be compressed and transmitted by the loss-less image compression portion 934 and the data transfer portion 933, respectively. Also, the data transfer portion 923 and the communications handling portion 922 receive and disassemble, respectively, the navigation output data caused to be assembled and transmitted by the communications handling portion 932 and the data transfer portion 933, respectively The navigation and UI integration portion 925 then causes the processor 120 to combine the frame buffer images, the visual elements and/or the navigation, output data received from the portable navigation system 104 with visual elements and other data pertaining to entertainment to create a single image for display on the screen 114.

As previously discussed, the manner in which visual elements are combined may be changed in response to sensing an approaching hand of a user via a proximity sensor or other mechanism. The proximity of a human hand may be detected through echo location with ultrasound, through sensing body heat emissions, or in other ways known to those skilled in the art. Where a proximity sensor is used, that proximity sensor may be incorporated into the head unit 106 (such as the depicted as sensor 926), or it may be incorporated into the portable navigation system 104. The processor 120 is caused to place the combined image in a frame buffer 929 by the user interface application 928, and from the frame buffer 929, the combined image is driven onto the screen 114 in a manner that will be familiar to those skilled in the art of graphics systems.

The navigation and UI integration portion 925 may cause various ones of the buttons and knobs 118a-118s to be assigned as proxies for various physical or virtual controls of the portable navigation device 104, as previously discussed. The navigation and UI integration portion 925 may also cause various visual elements pertaining to navigation to be displayed in different locations or to take on a different appearance from how they would otherwise be displayed on the screen 174, as also previously discussed. The navigation and UI integration portion 925 may also alter various details of these visual elements to give them an appearance that better matches other visual employed by the user interface 112 of the head unit 106. For example, the navigation and UI integration portion 925 may alter one or more of the colors of one or more of the visual elements pertaining to navigation to match or at least approximate a color scheme employed by the user interface 112, such as a color scheme that matches or at least approximates colors employed in the interior of or on the exterior of the vehicle into which the head unit 106 has been installed, or that matches or at least approximates a color scheme selected for the user interface 112 by a user, purveyor or installer of the head unit 106.

In the example of FIG. 7, one or more cables 702, 704, 706, 708 connect the navigation system 104 to the head unit 106 and other components of the entertainment system 102. The cables may connect the navigation system 104 to multiple sources, for example, they may include a direct connection 708 to the external antenna 113 and a data connection 706 to the head unit 106. In some examples, the navigation system 104 may be connected only to the head unit 106, which relays any needed signals from other interfaces such as the antenna 113.

For the features discussed above, the cables 702, 704, and 706 may carry video signals 220, audio signals 222, and commands or information 224 (FIG. 5) between the navigation system 104 and the head unit 106. The video signals 220 may include entire screen images or components, as discussed above. In some examples, dedicated cables, e.g., 702 and 704, are used for video signals 220 and audio signals 222 while a data cable, e.g., 706, is used for commands and information 224. The video connection 702 may be made using video-specific connections such as analog composite or component video or digital video such as DVI or LVDS. The audio connections 704 may be made using analog connections such as mono or stereo, single-ended or differential signals, or digital connections such as PCM, I2S, and coaxial or optical SPDIF. In some examples, the data cable 706 supplies all of the video signals 220, audio signals 222, and commands and information 224. The navigation system 104 may also be connected directly to the vehicle's information and power distribution bus 710 through at least one break-out connection 712. This connection 712 may carry vehicle information such as speed, direction, illumination settings, acceleration and other vehicle dynamics information from other electronics 714, raw or decoded GPS signals if the antenna 113 is connected elsewhere in the vehicle, and power from the vehicle's power supply 716. As noted above, there may be more than one data bus, and an individual device, such as the navigation system 104, may be connected to one or more than one of them, and may receive data signals directly from their sources rather than over one of the busses. Power may be used to operate the navigation system 104 and to charge a battery 720. In some examples, the battery 720 can power the navigation system 104 without any external power connection. A similar connection 718 carries such information and power to the head unit 106.

The data connections 706 and 712 may be a multi-purpose format such as USB, Firewire, UART, RS-232, RS-485, I2C, or an in-vehicle communication network such as controller area network (CAN), or they could be custom connections devised by the maker of the head unit 106, navigation system 104, or vehicle 100. The head unit 106 may serve as a gateway for the multiple data formats and connection types used in a vehicle, so that the navigation system 104 needs to support only one data format and connection type. Physical connections may also include power for the navigation system 104.

As shown in FIG. 8A, a docking 802 unit may be used to make physical connections between the navigation system 104 and the entertainment system 102. The same power, data, signal, and antenna connections 702, 704, 706, and 708 as described above may be made through the docking unit 802 through cable connectors 804 or through a customized connector 806 that allows the various different physical connections that might be needed to be made through a single connector. An advantage of a docking unit 802 is that it may provide a more stable connection for sensitive signals such as from the GPS antenna 113.

The docking unit 802 may also include features 808 for physically connecting to the navigation system 104 and holding it in place. This may function to maintain the data connections 804 or 806, and may also serve to position the navigation system 104 in a given position so that its interface 124 an be easily seen and used by the driver of the car.

In some examples, as shown in FIG. 8B, the docking unit 802 is integrated Into the head unit 106, and the navigation system's interface 124 serves as part or all of the head unit's interface 112. (The navigation system 104 is shown removed from the dock 802 in FIG. 8B; the connectors 804 and 806 are shown split into dock-side connectors 804a and 806a and device-side connectors 804b and 806b.) This can eliminate the cables connecting the docking unit 802 to the head unit 106. In the example of FIG. 8B, the antenna 113 is shown with a connection 810 to the head unit 106. If the navigation system's interlace 124 is being used as the primary interlace, some of the signals described above as being communicated from the head unit 106 to the navigation system 104 are in fact communicated from the navigation system 104 to the head unit 106. For example, if the navigation system's interface 124 is the primary interlace for the head unit 106, the connections 804 or 806 may need to communicate control signals from the navigation system 104 to the head unit 106 and may need to communicate video signals from the head unit 106 to the navigation system 104. The navigation system 104 can then be used to select audio sources and perform the other functions carried out by the head unit 106. In some examples, the head unit 106 has a first interface 112 and uses the navigation system 106 as a secondary interface. For example, the head unit 106 may have a simple interface for selecting audio sources and displaying the selection, but it will use the interface 124 of the navigation system 104 to display more detailed information about the selected source, such as the currently playing song, as in FIGS. 3A or 3D.

FIG. 14A provides a perspective view of an embodiment of docking between the portable navigation system 104 and the head unit 106 in a manner not unlike what has been discussed with regard to FIG. 8B. As depicted in FIG. 14A, the head unit 106 is meant to receive the portable navigation system 104 at a location in which the portable navigation system 104 is situated among the buttons and knobs 118a-s when docked. Once docked in this position, the screen 174 of the portable navigation system 104 occupies the same space as the screen 114 would occupy in earlier discussed embodiments of the head unit 106, thereby allowing the screen 174 to most easily take the place of the screen 114. With the screen 174 thus positioned, the user interface 124 of the portable navigation system 104 provides much of the same function and may provide much of the same user experience in providing a combined display of navigation and entertainment functionality as did the user interface 112 of earlier discussed embodiments. As previously discussed, some embodiments of the head unit 106 may further provide a screen 114 that may be smaller and/or simpler than the screen 174 that provides part of the user interlace 112 to be employed by a user at times when the portable navigation system 104 is not docked with the head unit 106. However, alternate embodiments of the head unit 106 may not provide such a separate screen, thereby relying entirely upon the screen 174 to provide such a visual component in support of user interaction.

FIG. 14B provides a perspective view of an embodiment of a similar docking between the portable navigation system 104 and a base unit 2106 serving as an entertainment system. Not unlike the head unit 106 of FIG. 14A, the base unit 2106 provides multiple buttons 2118a-d, and the docking of the portable navigation system 104 with the base unit 2106 provides the screen 174 as the main visual component of a user interface 124 (alternatively, the screen 174 may become the only such visual component). Also not unlike the head unit 106, the primary function of the base unit 2106 is to supply at least a portion of the hardware and software necessary to create an entertainment system by which audio entertainment may be listened to by playing audio through one or more speakers 2226 provided by the base unit 2106. However, in some embodiments of a simplified form of the base unit 2106, the base unit 2106 may have little in the way of functionality that Is independent of being docked with the portable navigation system 104. Such simpler embodiments of the base unit 2106 may rely on the portable navigation system 104 to have the requisite software and entertainment data to control the base unit 2106 to play audio provided by the portable navigation system 104.

Referring now to both FIGS. 14A and 14B, in some embodiments of docking between the portable navigation system 104 and either the head unit 106 or the base unit 2106, the user interlace 124 of the portable navigation system 104 automatically adopts a characteristic of a user interface installed in the device to which the portable navigation system is docked. For example, upon being docked to either of head unit 106 or the base unit 2106, the portable, navigation system 104 may automatically alter Its user interface 124 to adopt a color scheme, text font, shape of virtual button, language selection, or other user interface characteristic of either the head unit 106 or the base unit 2106, respectively, thereby providing a user interlace experience that is consistent in these ways with the user interface experience that is provided by either head unit 106 or the base unit 2106 when operated independently of the portable navigation system 104. In so doing, the portable navigation system 104 may receive visual elements from either the head unit 106 or the base unit 2106 in a manner similar to previously discussed embodiments of the head unit 106 receiving visual elements from the portable navigation system 104, including the use of loss-less compression.

Furthermore, upon being docked with either the head unit 106 or the base unit 2106, the user interface 124 of the portable navigation system 104 may automatically alter its user interface to make use of one or more of the buttons and knobs 118a-118s or the buttons 2118a-2118d in place of one or more of whatever physical or virtual controls that the user interface 124 may employ on the portable navigation system 104 when the portable navigation system 104 is used separately from either the head unit 106 or the base unit 2106.

Such features of the user interface 124 as adopting user interface characteristics or making use of additional buttons or knobs provided by either the head unit 106 or the base unit 2106 may occur when the portable navigation system 104 becomes connected to either the head unit 106 or the base unit 2106 in other ways than through docking, including through a cable-based or wireless connection (including wireless connections making use of ultrasonic, infrared or radio frequency signals). More specifically, the user interface 124 may automatically adopt characteristics of a user interface of either the head unit 106 or the base unit 2106 upon being brought into close enough proximity to engage in wireless communications with either. Furthermore, such wireless communications may enable the portable navigation system 104 to he used as a form of wireless remote control to allow a user to operate various aspects of either the head unit 106 or the base unit 2106 in a manner not unlike that in which many operate a television or stereo component through a remote control.

Still further, the adoption of user interlace characteristics by the user interface 124 may be mode-dependent based on a change in the nature of the connection between the portable navigation system 104 and either of the head unit 106 or the base unit 2106. More specifically, when the portable navigation system 104 is brought into close enough proximity to either the head unit 106 or the base unit 2106, the user interface 124 of the portable navigation system 104 may adopt characteristics of the user interface of either the head unit 106 or the base unit 2106. The portable navigation system 104 may automatically provide either physical or virtual controls to allow a user to operate the portable navigation system 104 as a handheld remote control to control various functions of either the head unit 106 or the base unit 2106. This remote control function would be carried out through any of a variety of wireless connections already discussed, including wireless communications based on radio frequency, infrared or ultrasonic communication. However, as the portable navigation system 104 is brought still closer to either the bead unit 106 or the base unit 2106, or when the portable navigation system 104 is connected with either the head unit 106 or the base unit 2106 through docking or a cable-based connection, the user interface 124 may automatically change the manner in which if adopts characteristics of the user interlace of either the head unit 106 or the base unit 2106. The portable navigation system 104 may cease to provide either physical or virtual controls and start to function more as a display of either the head unit 106 or the base unit 2106, and may automatically cooperate with the head unit 106 or the base unit 2106 to enable use of the various buttons or knobs on either the head unit 106 or the base unit 2106 as previously discussed with regard to docking.

Upon being docked or provided a cable-based connection to either the head unit 106 or the base unit 2106, the portable navigation system 104 may take on the behavior of being part of either the head unit 106 or the base unit 2106 to the extent that the combination of the portable navigation system 104 and either the head unit 106 or the base unit 2106 responds to commands received from a remote control of either the head unit 106 or the base unit 2106. Furthermore, an additional media device (not shown), including any of a wide variety of possible audio and/or video recording or playback devices, may be in communication with either combination such that commands received by the combination from the remote control are relayed to the additional media device.

Further, upon being docked with the base unit 2106, the behaviors that the portable navigation system 104 may take on as being part of the base unit 2106 may be modal in nature depending on the proximity of a user's hand in a manner not unlike what has been previously discussed with regard to the head unit 106. By way of example, the screen 174 of the portable navigation system 104 may display visual artwork pertaining to an audio recording (e.g., cover art of a music album) until a proximity sensor (not shown) of the base unit 2106 detects the approach of a user's hand towards the base unit 2106. Upon detecting the approach of the hand, the screen 174 of the portable navigation system 104 may automatically switch from displaying the visual artwork to displaying other information pertaining to entertainment. This automatic switching of images may be caused to occur on the presumption that the user is extending a hand to operate one or more controls. The user may also be provided with the ability to turn off this automatic switching of images. Not unlike the earlier discussion of the use of a proximity sensor with the head unit 106, a proximity sensor employed in the combination of the personal navigation system 104 and the base unit 2106 may be located either within the personal navigation system 104 or the base unit 2106.

In either the ease of a combination of the personal navigation system 104 with the head unit 106 or a combination of the personal navigation system 104 with the base unit 2106, a proximity sensor incorporated Into the personal navigation system 104 may be caused through software stored within the personal navigation system 104 to be assignable to being controlled and/or monitored, by either the head unit 106 or the base unit 2106 for any of a variety of purposes.

In some embodiments of interaction between the portable navigation system 104 and either the head unit 106 or the base unit 2106, the portable navigation system 104 may be provided the ability to receive and store new data from either the head unit 106 or the base unit 2106. This may allow the portable navigation system 104 to benefit from a connection that either the head unit 106 or the base unit 2106 may have to the Internet or to other sources of data that the portable navigation system 104 may not itself have. In other words, upon there being a connection formed between the portable navigation system 104 and either the head unit 106 or the base unit 2106 (whether that connection be wired, wireless, through docking, etc.), the portable navigation system 104 may be provided with access to updated maps or other data about a location, or may be provided with access to a collection of entertainment data (e.g., a library of MP3 files).

In some embodiments of interaction between the portable navigation system 104 and either the head unit 106 or the base unit 2106, software on one or more of these devices may perform a check of the other device to determine if the other device or the software of the other device meets one or more requirements before allowing some or all of the various described, forms of interaction to take place. For example, copyright considerations, electrical compatibility, nuances of feature interactions or other considerations may make it desirable for software stored within the portable navigation system 104 to refuse to interact with one or more particular forms of either a head unit 106 or a base unit 2106, or to at least limit the degree of interaction in some way. Similarly, it may be desirable for software stored within either fire head unit 106 or the base unit 2106 to refuse to interact with one or more particular forms of a portable navigation system 104, or to at least limit the degree of interaction in some way. Furthermore, it may be desirable for any one the portable navigation system 104, the head unit 106 or the base unit 2106 to refuse to interact with or to at least limit interaction with some other form of device that might otherwise have been capable of at least some particular interaction were it not for such an imposed refusal or limitation. Where interaction is simply limited, the interaction may be a limit against the use of a given communications protocol, a limit against the transfer of a given piece or type of data, a limit to a predefined lower bandwidth than is otherwise possible, or some other limit.

In some examples, a wireless connection 902 can be used to connect the navigation system 104 and the entertainment system 102, as shown in FIG. 9. Standard wireless data connections may be used, such as Bluetooth, WiFi, or WiMax, Proprietary connections could also be used. Each of the data signals 202 (FIG. 5) can be transmitted wirelessly, allowing the navigation system 104 to be located anywhere in the car and to make its connections to the entertainment system automatically. This may, for example, allow the user to leave the navigation system 104 in her purse or briefcase, or simply drop it on the seat or in the glove box, without having to make any physical connections. In some example, the navigation system Is powered by the battery 720, but a power connection 712 may still be provided to charge the battery 720 or power the system 104 if the battery 720 is depleted.

The wireless connection 902 may be provided by a transponder within the head unit 106 or another component of the entertainment system 102, or it may be a stand-alone device connected to the other entertainment system components through a wired connection, such as through the data bus 710. In some examples, the head unit 106 includes a Bluetooth connection for connecting to a user's mobile telephone 906 and allowing hands-free calling over the audio system. Such a Bluetooth connection can be used to also connect the navigation system 106, if the software 122 in the head unit 106 is configured to make such connections. In some examples, to allow a wirelessly-connected navigation system 104 to use the vehicle's antenna 113 for improved GPS reception, the antenna 113 is connected to the head unit 106 with a wired connection 810, and GPS signals are interpreted in the head unit and computed longitude and latitude values are transmitted to the navigation system 104 using the wireless connection 902. In the example of Bluetooth, a number of Bluetooth profiles may be used to exchange information, including, for example, advanced audio distribution profile (A2DP) to supply audio information, video distribution profile (VDP) for screen images, hands-free, human interface device (HID), and audio/video remote control (AVRCP) profiles for control information, and serial port and object push profiles for exchanging navigation data, map graphics, and other signals.

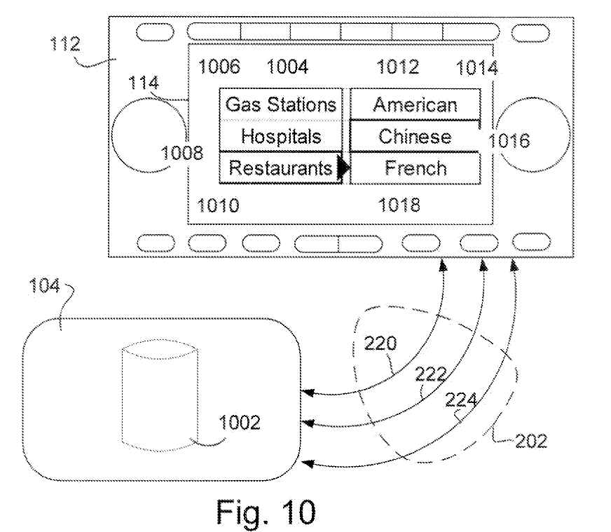

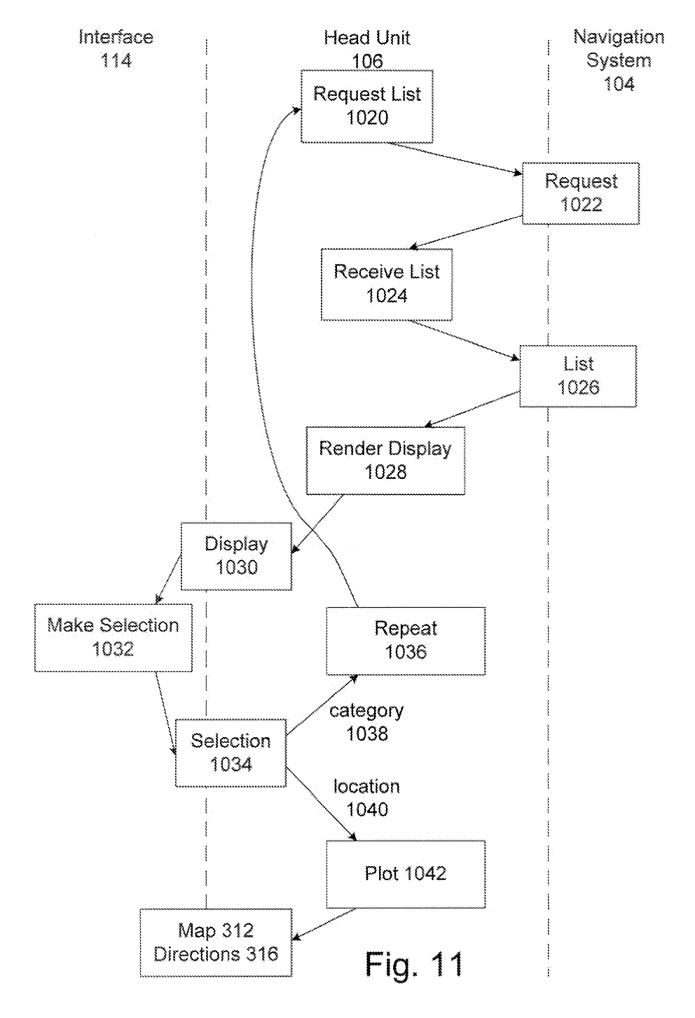

In some examples, as shown in FIGS. 10 and 11, the navigation system 104 may include a database 1002 of points of Interest and other information relevant to navigation, and the user interface 112 of the head unit 106 may be used to interact with this database. For example, if a user wants to find all the Chinese restaurants near his current location, he uses the controls 118 on the head unit 106 to move through a menu 1004 of categories such as “gas stations” 1006, “hospitals” 1008, and “restaurants” 1010, selecting “restaurants” 1010. He then uses the controls 118 to select a type of restaurant, in this case, “Chinese” 1016, from a list 1012 of “American” 1014, “Chinese” 1016, and “French” 1018. Examples of a user interlace for such a database are described in U.S. patent application Ser. No. 11/317,558, filed Dec. 22, 2005, which is incorporated here by reference.

This feature may be implemented using the process shown in FIG. 11. The bead unit 106 queries the navigation system 104 by requesting 1020 a list of categories. This request 1022 may include requesting the categories, an index number and name for each, and the number of entries in each category. Upon receiving 1024 the requested list 1026, the head unit 106 renders 1028 a graphical display element and displays it 1030 on the display 114. This display may be generated using elements in the head unit's memory or may be provided by the navigation system 104 to the head unit 106 as described above. Once the user makes 1032 a selection 1034, the head unit either repeats 1036 the process of requesting 1020 a list 1026 for selected category 1038 or, if the user has selected a list item representing a location 1040, the head unit 106 plots 1042 that location 1040 on the map 312 and displays directions 316 to that location 1040. Similar processes may be used to allow the user to add, edit, and delete records in the database 1002 through the interfaced 112 of the head unit 106. Other interactions that the user may be able to have with the database 1002 include requesting data about a point of interest, such as the distance to it, requesting a list of available categories, requesting a list of available locations, or looking up an address based on the user's knowledge of some part of it, such as the house number, street name, city, zip code, state, or telephone number. The user may also be able to enter a specific address.

Other implementations are within the scope of the following claims and other claims to which the applicant may be entitled.

What is claimed is:

1. A personal navigation device comprising:
an interlace capable of receiving navigation input data from a media device;
a processor structured to generate a visual element indicating a current location from the navigation input data;
a frame buffer to store the visual element; and
a storage device in which software is stored that when executed by the processor causes the processor to:
repeatedly check, the visual element in the frame buffer to determine if the visual element has been updated since a previous instance of checking the visual element: and
compress the visual element and transmit the visual element to the media device if the visual element has not been updated between two instances of checking the visual element.

2. The personal navigation device of claim 1, wherein the software further causes the processor to employ loss-less compression to compress the visual element.

3. The personal navigation device of claim 1, wherein the software further causes the processor to determine if the visual element has been updated by comparing every Nth horizontal line of the visual element from a first instance of checking the visual element to corresponding horizontal lines of the visual element from a second instance of checking the visual element, wherein N has a value of at least 2.

4. The personal navigation device of claim 1, wherein, the software further causes the processor to compress the visual element by serializing pixels of the visual element into a stream of serialized pixels and creating a description of the serialized pixels in which a given pixel color is specified when the pixel color is different from a preceding pixel color and in which the specification of the given pixel color is accompanied by a value indicating the quantity of adjacent pixels that have the given pixel color.

5. The personal navigation device of claim 1, wherein the media device is installed within a vehicle, and the navigation input data comprises data from at least one sensor of the vehicle.

6. The personal navigation device of claim 1, wherein the software further causes the processor to transmit a piece of data pertaining to a control of the personal navigation device to the media device to enable the media device to assign a control of the media device as a proxy for the control of the personal navigation device.

7. The personal navigation device of claim 6, wherein the software further causes the processor to:
receive a indication of an actuation of the control of the media device; and
respond to the indication in a manner substantially identical to the manner in which an actuation of the control of the personal navigation device is responded to.

8. The personal navigation device of claim 1, wherein the repeated checking of the visual element to determine if the visual element has been updated comprises repeatedly checking the frame buffer to determine if the entirety of the frame buffer has been updated.

9. A method comprising:
receiving navigation input data from a media device;
generating a visual element indicating a current location from the navigation input data;
storing the visual element In a storage device of a personal navigation device;
repeatedly checking the visual element in the storage device to determine if the visual element has been updated between two instances of checking the visual element; and
compressing the visual element and transmitting the visual element to the media device if the visual element has not been updated between two Instances of checking the visual element.

10. The method of claim 9, further comprising employing loss-less compression in compressing the visual element.

11. The method of claim 9, wherein determining if the visual element has been updated comprises comparing every Nth horizontal line of the visual element from a first instance of checking the visual element to corresponding horizontal lines of the visual element from a second instance of checking the visual element, wherein N has a value of at least 2.

12. The method of claim 9, wherein, compressing the visual element comprises:
serializing pixels of the visual element into a stream of serialized pixels;
creating a description of the serialized pixels in which a given pixel color is specified when the pixel color is different from a preceding pixel color and in which the specification of the given pixel color is accompanied by a value indicating the quantity of adjacent pixels that have the given pixel color.

13. The method of claim 9, further comprising transmitting a piece of data pertaining to a control of the personal navigation device to the media device to enable the media device to assign a control of the media device as a proxy for the control of the personal navigation device.

14. The method of claim 13, further comprising:
receiving a indication, of an actuation of the control of the media, device; and
responding to the indication in a manner substantially identical to the manner in which an actuation of the control of the personal navigation device is responded to.

15. A computer readable medium encoding instructions to cause a personal navigation device to:
receive navigation input data from a media device;
repeatedly cheek a visual element that is generated by the personal navigation device from the navigation input data, is stored by the personal navigation device, and that indicates a current position, to determine if the visual element has been updated between two Instances of checking the visual element; and
compress the visual element and transmit the visual element to the media device if the visual element has not been updated between two instances of checking the visual element.

16. The computer readable medium of claim 15, wherein the instructions further cause the personal navigation device to employ loss-less compression in compressing the visual element.

17. The computer readable medium of claim 15, wherein the instructions further cause the personal navigation device to determine if the visual element has been updated by comparing every Nth horizontal line of the visual element from a first instance of checking the visual element to corresponding horizontal lines of the visual element from a second instance of checking the visual element wherein N has a value of at least 2.

18. The computer readable medium of claim 15, wherein the instructions further cause the personal navigation device to compress the visual element by serializing pixels of the visual element into a stream of serialized pixels and creating a description of the serialized pixels in which a given pixel color is specified when the pixel color is different from a preceding pixel color and in which the specification of the given pixel color is accompanied by a value indicating the quantity of adjacent pixels that have the given pixel color.

19. The computer readable medium of claim 15, wherein the instructions further cause the personal, navigation device to transmit a piece of data pertaining to a control of the personal navigation device to the media device to enable the media device to assign a control of the media device as a proxy for the control of the personal navigation device.

20. A media device comprising:
an interface capable of receiving a visual element indicating a current location from a personal navigation device;
a screen;
a processor structured to provide an image indicating the current location and providing entertainment information for display on the screen from at least the visual element; and
a storage device in which software is stored that when executed by the processor causes the processor to:
define a first layer and a second layer;
store the visual element in the second layer;
store another visual element pertaining to the entertainment information in the first layer; and
combine the first layer and the second layer to create the image with the first layer overlying the second layer such that the another visual element overlies the visual element,

21. The media device of claim 20, further comprising a receiver capable of receiving a GPS signal from a satellite, and wherein the processor is further structured to provide navigation input data corresponding to that GPS signal to the personal navigation device.

22. The media device of claim 20, wherein the software further causes the processor to alter a visual characteristic of the visual element.

23. The media device of claim 22, wherein the visual characteristic of the visual element is one of a set consisting of a color, a font and a shape.

24. The media device of claim 23, wherein the visual characteristic that is altered is a color, and wherein the color is altered to at least approximate a color of a vehicle into which the media device is installed.

25. The media device of claim 23, wherein the visual characteristic that is altered is a color, and wherein the color is altered to at least approximate a color specified by a user of the media device.

26. The media device of claim 20, further comprising a physical control, and wherein the software further causes the processor to assign the physical control to serve as a proxy for a control of the personal navigation device.

27. The media device of claim 26, wherein the control of the personal navigation device comprises a physical control of the personal navigation device.

28. The media device of claim 26, wherein the control of the personal navigation device comprises a virtual control having a corresponding additional visual element that is received from the personal navigation device and that the software further causes the processor to refrain from displaying on the screen.

29. The media device of claim 20, further comprising a proximity sensor, and wherein the software further causes the processor to alter at least a portion of the another visual element in response to detecting the approach of a portion of the body of a user of the media device through the proximity sensor.

30. The media device of claim 29, wherein the another visual element is enlarged such that it overlies a relatively larger portion of the visual element.

31. A method comprising:
receiving a visual element indicating a current location from a personal navigation device;
defining a first layer and a second layer;
storing the visual element in the second layer;
storing another visual element pertaining to the entertainment information in the first layer;
combining the first layer and the second layer to provide an image with the first layer overlying the second layer such that the another visual element overlies the visual element; and
displaying the image on a screen of a media device.

32. The method of claim 31, further comprising:
receiving a GPS signal from a satellite; and
providing navigation input data corresponding to that GPS signal to the personal navigation device.

33. The method of claim 31, further comprising altering a visual characteristic of the visual element.

34. The method of claim 33, wherein altering the visual characteristic of the visual element comprises altering one of a set consisting of a color of the visual element, a font of the visual element and a shape of the visual element.

35. The method of claim 34, wherein altering the visual characteristic of the visual element comprises altering the color of the visual element to at least approximate a color of a vehicle into which the media device is installed.

36. The method of claim 34, wherein altering the visual characteristic of the visual element comprises altering the color of the visual element to at least approximate a color specified by a user of the media device.

37. The method of claim 31, further comprising assigning a physical control of the media device to serve as a proxy for a control of the personal navigation device.

38. The method of claim 37, further comprising:
receiving an additional visual element from the personal navigation device that corresponds to the control of the personal navigation device for which the physical control of the media device serves as a proxy; and
refraining from displaying the additional visual element on the screen.

39. The method of claim 31, further comprising altering at least a portion of the another visual element in response to detecting the approach of a portion of the body of a user of the media device.

40. A computer readable medium encoding instructions to cause a media device to:
receive a visual element indicating a current location from a personal navigation device;
define a first layer and a second layer;
store the visual element in the second layer;
store another visual element pertaining to the entertainment information in the first layer;
combine the first layer and the second layer to provide an image with the first layer overlying the second layer such that the another visual element overlies the visual element; and
display the image on a screen of the media device.

41. The computer readable medium of claim 40, wherein the instructions further cause the media device to:
receive a GPS signal from a satellite; and
provide navigation input data corresponding to that GPS signal to the personal navigation device.

42. The computer readable medium of claim 40, wherein the instructions further cause the media device to alter a visual characteristic of the visual element.

43. The computer readable medium of claim 40, wherein the visual characteristic of the visual element is one of a set consisting of a color, a font and a shape.

44. The computer readable medium of claim 40, wherein the instructions further cause the media device to assign a physical control of the media device to serve as a proxy for a control of the personal navigation device.

45. The computer readable medium of claim 44, wherein the instructions further cause the media device to:
receive an additional visual element from the personal navigation device that corresponds to the control of the personal navigation device for which the physical control of the media device serves as a proxy; and
retrain from displaying the additional visual element on the screen.

46. A media device comprising;
at least one speaker;
an interface enabling a connection between the media device and a personal navigation device to be formed, and enabling audio data stored on the personal navigation device to be played on the at least one speaker; and
a user interlace comprising a plurality of physical controls capable of being actuated by a user of the media device to control a function of the playing of the audio data stored on the personal navigation device during a time when there is a connection between the media device and the personal navigation device.

47. The media device of claim 46, wherein the media device is structured to interact with the personal navigation device to employ a screen of the personal navigation device as a component of the user interface of the media device during a time when there Is a connection between the media device and the personal navigation device.

48. The media device, of claim 47, wherein the media device is structured to assign the plurality of physical controls to serve as proxies for a corresponding plurality of controls of the personal navigation device during a time when the screen of the personal navigation device is employed as a component of the user interface of the media device.

49. The media device of claim 46, wherein the media device is structured to transmit to the personal navigation device an indication, of a characteristic of the user interface of the personal navigation device to be altered during a time when there is a connection between the media device and the personal navigation device.

50. The media device of claim 49, wherein the characteristic of the user interface of the personal navigation device to be altered is one of a set consisting of a color, a font, and a shape of a visual element displayed on a screen of the personal navigation device.

51. The media device of claim 46, wherein die media device is structured to accept commands from the personal navigation device during a time when there is a wireless connection between the media device and the personal navigation device to enable the personal navigation device to serve as a remote control of the media device.

52. The media device of claim 51, wherein the media device further comprises an additional interface enabling a connection between the media device and another media device through which the media device is able to relay a command received from the personal navigation device to the another media device.

53. A method comprising:
detecting that a connection exists with a personal navigation device and a media device;
receiving audio data from the personal navigation device;
playing the audio data through at least one speaker of the media device; and
transmitting a command to the personal navigation device pertaining to the playing of the audio data in response to an actuation of at least one physical control of the media device.

54. The method of claim 53, further comprising:
generating a visual element pertaining to the playing of the audio data; and
transmitting the visual element to the personal navigation device for display on a screen of the personal navigation device.

55. The method of claim 53, further comprising transmitting to the personal navigation device an indication of a characteristic of a user interface of the personal navigation device to be altered.

56. The method, of claim 55, wherein transmitting the indication of a characteristic comprises transmitting a specification of one of a set of characteristics consisting of a color, a font, and a shape of a virtual button.

57. The method of claim 53, further comprising accepting commands from the personal navigation device through a wireless connection, to enable the personal navigation device to serve as a remote control of the media device.

58. The media device of claim 57, further comprising relaying a command received from the personal navigation device to another media device.
